(19) United States
(12) Patent Application Publication
(10) Pub. No.: US 2023/0146565 A1
(43) Pub. Date: May 11, 2023

(54) METHOD FOR PROVIDING BATTLE ROYALE GAME CAPABLE OF ALLOWING ITEMS TO BE UPGRADED AND SERVER USING THE SAME

(71) Applicant: Wonder People Co., Ltd., Seoul (KR)

(72) Inventor: Min HUR, Seoul (KR)

(21) Appl. No.: 17/940,203

(22) Filed: Sep. 8, 2022

(30) Foreign Application Priority Data
Nov. 9, 2021 (KR) 10-2021-0152768
Jun. 16, 2022 (KR) 10-2022-0073829

(51) Int. Cl. A63F 13/69; A63F 13/77; A63F 13/837

(52) U.S. Cl. CPC A63F 13/69; A63F 13/77; A63F 13/837

(57) ABSTRACT

Method for upgrading items is provided. The method includes steps of: (a) on condition that information on 1-st main item to n-th main item, information on 1-st sub item to n-th sub item, and 1-st hierarchy information to n-th hierarchy information have been managed, acquiring k-th main upgrade request for upgrading k-th main item and k-th sub upgrade request for upgrading k-th sub item; and (b) performing (i) main upgrade process which upgrades the k-th main item and provides upgraded status of the k-th main item to the specific player, in response to determining that (k_1)-st condition for upgrading the k-th main item is satisfied, and (ii) sub upgrade process which upgrades the k-th sub item and provides upgraded status of the k-th sub item to the specific player, in response to determining that (k_2)-nd condition for upgrading the k-th sub item is satisfied.

### CROSS REFERENCE TO RELATED APPLICATION

This application claims the benefit of priority to Korean Provisional Patent Application No. 10-2021-0152768, filed on Nov. 9, 2021 and Korean Patent Application No. 10-2022-0073829, filed on Jun. 16, 2022, the entire contents of which being incorporated herein by reference.

### FIELD OF THE DISCLOSURE

The present disclosure relates to a method for providing a battle royale game and a server using the same; and more particularly, to the method for providing a battle royale game capable of allowing items used for survival of players participating in the battle royale game to be upgraded, and the server using the same.

### BACKGROUND OF THE DISCLOSURE

Players participating in conventional battle royale games were unable to upgrade items (for example, weapons and protective items, etc.) spawned in the field (battle-possible area).

Accordingly, conventionally, the players had to repeat playing through a simple manner of participating in the battle by using the items such as weapons/protective items spawned in the field in the acquired state as they are, and there was a problem that the players easily lost interests due to this.

In addition, each of basic performances of each of items spawned in the field has various spectra, and thus there may be cases where some players acquire items with their corresponding good basic performances and other players acquire items with their corresponding inferior basic performances, but as explained above, if the basic performances of the items spawned in the field cannot be upgraded and if the items must be used in the state acquired as they are, in spite of gaming skills of the users, the destiny of the players is considerably subordinate to coincidental elements (for example, whether items with the good basic performances are spawned near the players), and in this regard, the users gradually lose interests in the battle royale game, and accordingly, there was a problem that the lifespan of the battle royale game which has cost astronomical money for development quickly shortened.

Accordingly, an improved solution for solving the problems above is demanded.

### SUMMARY OF THE DISCLOSURE

It is an object of the present disclosure to solve all the aforementioned problems.

It is another object of the present disclosure to support players participating in a battle royale game to be capable of upgrading their possessed items.

It is still another object of the present disclosure to support the players participating in the battle royale game to easily upgrade the possessed items by providing upgrade tree information to the players.

It is still yet another object of the present disclosure to support the players participating in the battle royale game to easily upgrade the possessed items by providing an inventory status window for checking the possessed items to the players.

It is still yet another object of the present disclosure to prevent the players participating in the battle royale game from losing interests in the game easily.

In accordance with one aspect of the present disclosure, there is provided a method for providing a battle royale game which upgrades items, comprising steps of: (a) on condition that (i) information on each of a 1-st main item to an n-th main item, (ii) information on at least one 1-st sub item corresponding to the 1-st main item to at least one n-th sub item corresponding to the n-th main item, wherein each of the 1-st sub item to the n-th sub item be consumed respectively for upgrading each of the 1-st main item to the n-th main item includes at least part of each of a (1_1)-st sub item to an (n_1)-st sub item directly consumed respectively for upgrading each of the 1-st main item to the n-th main item and each of a (1_2)-nd sub item to an (n_2)-nd sub item indirectly consumed respectively for upgrading the 1-st main item to the n-th main item, and (iii) 1-st hierarchy information to n-th hierarchy information, wherein each of the 1-st hierarchy information to the n-th hierarchy information includes each of information on hierarchy among levels of the 1-st main item to information on hierarchy among levels of the n-th main item, each of information on hierarchy among levels of the 1-st sub item to information on hierarchy among levels of the n-th sub item, and each of information on hierarchy between each of the levels of the 1-st main item and each of the levels of the 1-st sub item to information on hierarchy between each of the levels of the n-th main item and each of the levels of the n-th sub item, have been stored and managed in a database, a server acquiring at least part of a k-th main upgrade request for upgrading a k-th main item and a k-th sub upgrade request for upgrading a k-th sub item from a specific user terminal corresponding to a specific player among a plurality of players participating in the battle royale game, wherein the k is any one integer among 1 to n; and (b) the server performing at least part of (i) a main upgrade process which upgrades the k-th main item and provides an upgraded status of the k-th main item to the specific player, in response to determining that a (k_1)-st condition for upgrading the k-th main item is satisfied by referring to information on one or more specific possessed items of the specific player, information on the k-th main item, information on the k-th sub item and k-th hierarchy information, wherein the k-th hierarchy information is information on hierarchy among levels of the k-th main item, information on hierarchy among levels of the k-th sub item, and information on hierarchy between each of the levels of the k-th main item and each of the levels of the k-th sub item, and (ii) a sub upgrade process which upgrades the k-th sub item and provides an upgraded status of the k-th sub item to the specific player, in response to determining that a (k_2)-nd condition for upgrading the k-th sub item is satisfied by referring to the information on the specific possessed items of the specific player, the information on the k-th sub item and the k-th hierarchy information.

As one example, there is provided a method, wherein the step of (a) includes steps of: (a1) on condition that information on each of the 1-st main item to the n-th main item, information on the at least one 1-st sub item to the at least one n-th sub item and the 1-st hierarchy information to the n-th hierarchy information have been stored and managed in the database, the server acquiring a request for k-th upgrade tree information corresponding to the k-th main item from the specific user terminal, wherein the k-th upgrade tree information is generated by referring to at least part of information on the k-th main item, information on the k-th sub item and the k-th hierarchy information; and (a2) the server providing the k-th upgrade tree information to the specific user terminal and thus supporting the specific user terminal to generate at least part of the k-th main upgrade request for upgrading the k-th main item and the k-th sub upgrade request for upgrading the k-th sub item by referring to the k-th upgrade tree information, thereby acquiring at least part of the k-th main upgrade request and the k-th sub upgrade request from the specific user terminal.

There is provided a method, wherein, at the step of (a2), the server provides the k-th upgrade tree information to the specific user terminal and thus supports the specific user terminal to display the k-th upgrade tree information through a 1-st display area, thereby supporting a specific user of the specific user terminal to generate at least part of the k-th main upgrade request and the k-th sub upgrade request, and wherein the server further supports the specific user terminal to display a 1-st visual effect through at least one section in a (1_1)-st display area of the 1-st display area, wherein the (1_1)-st display area is an area where at least part of a k-th main possessed item and a k-th sub possessed item is displayed, and wherein the k-th main possessed item and the k-th sub possessed item are items corresponding to the specific possessed items of the specific player among the k-th main item and the k-th sub item.

As one example, there is provided a method, wherein the step of (a1) has steps of: (a1_1) on condition that information on each of the 1-st main item to the n-th main item, information on the at least one 1-st sub item to the at least one n-th sub item and the 1-st hierarchy information to the n-th hierarchy information have been stored and managed in the database, the server acquiring a request for specific inventory information including information on the specific possessed items of the specific player from the specific user terminal; (a1_2) the server (i) transmitting the specific inventory information generated by referring to the information on the specific possessed items to the specific user terminal, and (ii) supporting the specific user terminal to display the specific inventory information through a 2-nd display area and further supporting the specific user terminal to display a first user interface through at least one section in a (2_1)-st display area of the 2-nd display area, wherein the (2_1)-st display area is an area where at least part of a k-th main possessed item and a k-th sub possessed item is displayed, and wherein the k-th main possessed item and the k-th sub possessed item are items corresponding to the specific possessed items of the specific player among the k-th main item and the k-th sub item, and wherein the first user interface is a user interface for acquiring a request for the k-th upgrade tree information from the specific user terminal; and (a1_3) the server acquiring a selection signal for the first user interface as a request for the k-th upgrade tree information from the specific user terminal.

As one example, there is provided a method, wherein the step of (a) includes steps of: (a3) on condition that information on each of the 1-st main item to the n-th main item, information on the at least one 1-st sub item to the at least one n-th sub item and the 1-st hierarchy information to the n-th hierarchy information have been stored and managed in the database, the server acquiring specific inventory information including information on the specific possessed items of the specific player from the specific user terminal; (a4) the server transmitting the specific inventory information generated by referring to information on the specific possessed items of the specific player to the specific user terminal and thus supporting the specific user terminal to display the specific inventory information through a 2-nd display area, and further supporting the specific user terminal to display a 2-nd visual effect through at least one section in a (2_2)-nd display area of the 2-nd display area, wherein the (2_2)-nd display area is an area where a subset of the specific possessed items corresponding to at least part of the (k_1)-st condition and the (k_2)-nd condition among the specific possessed items of the specific player is displayed; and (a5) the server supporting a specific user of the specific user terminal to generate at least part of the k-th main upgrade request and the k-th sub upgrade request by referring to information on the subset of the specific possessed items, thereby acquiring at least part of the k-th main upgrade request and the k-th sub upgrade request from the specific user terminal.

As one example, there is provided a method, wherein the step of (a) includes steps of: (a6) on condition that information on each of the 1-st main item to the n-th main item, information on the at least one 1-st sub item to the at least one n-th sub item and the 1-st hierarchy information to the n-th hierarchy information have been stored and managed in the database, the server acquiring a request for specific inventory information including information on the specific possessed items of the specific player from the specific user terminal; (a7) the server transmitting the specific inventory information generated by referring to the specific possessed items to the specific user terminal and thus supporting the specific user terminal to display the specific inventory information through a 2-nd display area, wherein the server performs at least one of (i) a process of supporting the specific user terminal to display at least part of information on at least one 1-st possessed item satisfying the (k_1)-st condition and at least one 2-nd possessed item satisfying the (k_2)-nd condition among the specific possessed items through a (2_3)-rd display area of the 2-nd display area and (ii) a process of determining the 2-nd possessed item satisfying the (k_2)-nd condition among the specific possessed items of the specific player, and supporting the specific user terminal to display information on the 2-nd possessed item through the (2_3)-rd display area of the 2-nd display area; and (a8) the server supporting a specific user of the specific user terminal to generate at least part of the k-th main upgrade request and the k-th sub upgrade request by referring to at least part of information on the 1-st possessed item and information on the 2-nd possessed item, thereby acquiring at least part of the k-th main upgrade request and the k-th sub upgrade request from the specific user terminal.

As one example, there is provided a method, wherein, at the step of (b), on condition that a state of the plurality of players waiting in a waiting space in the battle royale game is a 1-st state, and a state of the plurality of players playing in the battle royale game is a 2-nd state, the server performs at least part of: a 1-st process, in response to determining that the (k_1)-st condition is not satisfied, of (1) increasing a probability of a 1-st non-possessed item being contained in a 1-st supply box to be provided in the 2-nd state by referring to at least part of (i) 1-st specific non-possessed item information necessary for the specific player to satisfy the (k_1)-st condition, (ii) 1-st statistic information on the 1-st specific non-possessed item information and 1-st another non-possessed item information necessary for at least one another player to satisfy the (k_1)-st condition, (iii) at least one player level corresponding to at least part of the specific player and another player and (iv) class information corresponding to the specific player and the another player, and (2) determining a 1-st forwarding position of the 1-st supply box by referring to a position of the specific player and a position of the another player, and a 2-nd process, in response to determining that the (k_2)-nd condition is not satisfied, of (1) increasing a probability of a 2-nd non-possessed item being contained in a 2-nd supply box to be provided in the 2-nd state by referring to at least part of (i) 2-nd specific non-possessed item information necessary for the specific player to satisfy the (k_2)-nd condition, (ii) 2-nd statistic information on the 2-nd specific non-possessed item information and 2-nd another non-possessed item information necessary for the another player to satisfy the (k_2)-nd condition, (iii) the player level corresponding to at least part of the specific player and the another player and (iv) class information corresponding to the specific player and the another player, and (2) determining a 2-nd forwarding position of the 2-nd supply box by referring to the position of the specific player and a position of the another player.

As one example, there is provided a method, wherein the k-th main item includes a (k_1)-th level main item to a (k_mk)-th level main item, and wherein the k-th sub item includes at least part of a (k_1_1)-st sub item directly consumed for upgrading the (k_1)-st level main item and a (k_2_1)-st sub item indirectly consumed for upgrading the (k_1)-st level main item, at least part of a (k_1_2)-nd sub item directly consumed for upgrading the (k_2)-nd level main item and a (k_2_2)-nd sub item indirectly consumed for upgrading the (k_2)-nd level main item, ..., and at least part of a (k_1_(mk-1) )-th sub item directly consumed for upgrading the (k_(mk-1) ) -th level main item and a (k_2_(mk-1)) -th sub item indirectly consumed for upgrading the (k_(mk-1) )-th level main item.

As one example, there is provided a method, wherein, at the step of (a), the server acquires a (k_jk)-th main upgrade request for upgrading a (k_jk)-th level main item among the (k_1)-st level main item to the (k_mk)-th level main item from the specific user terminal as the k-th main upgrade request, and wherein, at the step of (b), in the main upgrade process, in response to determining that the (k_1)-st condition is satisfied by referring to (i) the specific possessed items, (ii) information on the (k_jk)-th level main item and (k_(j+1)k)-th level main item, (iii) information on (k_1_jk)-th sub item and (iv) (k_jk)-th hierarchy information, wherein the (k_jk)-th hierarchy information is information on hierarchy among levels of the (k_jk)-th level main item and (k_(j+1)k)-th level main item, information on hierarchy between each of the levels of the (k_jk) -th level main item and each of the levels of the (k_1_jk)-th sub item, and information on hierarchy between each of the levels of the (k(j+1)k)-th level main item and each of the levels of the (k_1_jk)-th sub item, the server provides the (k_(j+1)k)-th level main item, which is generated by upgrading the (k_jk)-th level main item by using the (k_1_jk)-th sub item, to the specific player.

As one example, there is provided a method, wherein the step of (a) includes steps of: (a9) on condition that information on each of the 1-st main item to the n-th main item, information on the at least one 1-st sub item to the at least one n-th sub item and the 1-st hierarchy information to the n-th hierarchy information have been stored and managed in the database, the server acquiring a request for (k_jk)-th upgrade tree information corresponding to (k_jk)-th level main item among the (k_1)-th level main item to the (k_mk)-th level main item from the specific user terminal, wherein the (k_jk)-th upgrade tree information is generated by referring to at least part of (i) information on the (k_jk)-th level main item and (k_(j+1)k)-th level main item, (ii) information on (k_1_jk)-th sub item and (iii) information on hierarchy among levels of the (k_jk)-th level main item and (k_(j+1)k)-th level main item, information on hierarchy between each of the levels of the (k_jk)-th level main item and each of the levels of the (k_1_jk)-th sub item, and information on hierarchy between each of the levels of the (k_(j+1)k)-th level main item and each of the levels of the (k_1_jk)-th sub item; and (a10) the server providing the (k_jk)-th upgrade tree information to the specific user terminal and thus supporting the specific user terminal to generate (k_jk)-th main upgrade request for upgrading the (k_jk) -th level main item by referring to the (k_jk)-th upgrade tree information, thereby acquiring the (k_jk)-th main upgrade request from the specific user terminal as the k-th main upgrade request.

As one example, there is provided a method, wherein at the step of (a10), the server provides the (k_jk)-th upgrade tree information to the specific user terminal and thus supports the specific user terminal to display the (k_jk)-th upgrade tree information through a 1-st display area, thereby supporting the specific user terminal to generate the (k_jk)-th main upgrade request for upgrading the (k_jk)-th level main item, wherein the server further supports the specific user terminal to display a 3-rd visual effect through at least one section in a (1_2)-nd display area of the 1-st display area, wherein the (1_2)-nd display area is an area where at least part of a specific k-th lower level item is displayed, and wherein the specific k-th lower level item is at least one of (i) at least part of a (k_1_1)-st sub item directly consumed for upgrading the (k_1)-st level main item and a (k_2_1)-st sub item indirectly consumed for upgrading the (k_1)-st level main item, at least part of a (k_1_2)-nd sub item directly consumed for upgrading the (k_2)-nd level main item and a (k_2_2)-nd sub item indirectly consumed for upgrading the (k_2)-nd level main item, ..., and at least part of a (k_1_(jk-1))-st sub item directly consumed for upgrading the (k_(jk-1))-st level main item and a (k_2_(jk-1))-st sub item indirectly consumed for upgrading the (k_(jk-1))-st level main item, and (ii) an item of the (k_1)-st level main item to the (k_(jk-1))-st level main item.

In accordance with another aspect of the present disclosure, there is provided a server for providing a battle royale game which upgrades items, comprising: at least one memory that stores instructions; and at least one processor configured to execute the instructions to perform or support another device to perform processes of: (I) on condition that (i) information on each of a 1-st main item to an n-th main item, (ii) information on at least one 1-st sub item corresponding to the 1-st main item to at least one n-th sub item corresponding to the n-th main item, wherein each of the 1-st sub item to the n-th sub item be consumed respectively for upgrading each of the 1-st main item to the n-th main item includes at least part of each of a (1_1)-st sub item to an (n_1)-st sub item directly consumed respectively for upgrading each of the 1-st main item to the n-th main item and each of a (1_2)-nd sub item to an (n_2)-nd sub item indirectly consumed respectively for upgrading the 1-st main item to the n-th main item, and (iii) 1-st hierarchy information to n-th hierarchy information, wherein each of the 1-st hierarchy information to the n-th hierarchy information includes each of information on hierarchy among levels of the 1-st main item to information on hierarchy among levels of the n-th main item, each of information on hierarchy among levels of the 1-st sub item to information on hierarchy among levels of the n-th sub item, and each of information on hierarchy between each of the levels of the 1-st main item and each of the levels of the 1-st sub item to information on hierarchy between each of the levels of the n-th main item and each of the levels of the n-th sub item, have been stored and managed in a database, (I) a process of acquiring at least part of a k-th main upgrade request for upgrading a k-th main item and a k-th sub upgrade request for upgrading a k-th sub item from a specific user terminal corresponding to a specific player among a plurality of players participating in the battle royale game, wherein the k is any one integer among 1 to n; and (II) performing at least part of (i) a main upgrade process which upgrades the k-th main item and provides an upgraded status of the k-th main item to the specific player, in response to determining that a (k_1)-st condition for upgrading the k-th main item is satisfied by referring to information on one or more specific possessed items of the specific player, information on the k-th main item, information on the k-th sub item and k-th hierarchy information, wherein the k-th hierarchy information is information on hierarchy among levels of the k-th main item, information on hierarchy among levels of the k-th sub item, and information on hierarchy between each of the levels of the k-th main item and each of the levels of the k-th sub item, and (ii) a sub upgrade process which upgrades the k-th sub item and provides an upgraded status of the k-th sub item to the specific player, in response to determining that a (k_2)-nd condition for upgrading the k-th sub item is satisfied by referring to the information on the specific possessed items of the specific player, the information on the k-th sub item and the k-th hierarchy information.

As one example, there is provided a server, wherein the process of (I) includes processes of: (I_1) on condition that information on each of the 1-st main item to the n-th main item, information on the at least one 1-st sub item to the at least one n-th sub item and the 1-st hierarchy information to the n-th hierarchy information have been stored and managed in the database, the processor acquiring a request for k-th upgrade tree information corresponding to the k-th main item from the specific user terminal, wherein the k-th upgrade tree information is generated by referring to at least part of information on the k-th main item, information on the k-th sub item and the k-th hierarchy information; and (I_2) the processor providing the k-th upgrade tree information to the specific user terminal and thus supporting the specific user terminal to generate at least part of the k-th main upgrade request for upgrading the k-th main item and the k-th sub upgrade request for upgrading the k-th sub item by referring to the k-th upgrade tree information, thereby acquiring at least part of the k-th main upgrade request and the k-th sub upgrade request from the specific user terminal.

As one example, there is provided a server, wherein, at the process of (I_2), the processor provides the k-th upgrade tree information to the specific user terminal and thus supports the specific user terminal to display the k-th upgrade tree information through a 1-st display area, thereby supporting a specific user of the specific user terminal to generate at least part of the k-th main upgrade request and the k-th sub upgrade request, and wherein the processor further supports the specific user terminal to display a 1-st visual effect through at least one section in a (1_1)-st display area of the 1-st display area, wherein the (1_1)-st display area is an area where at least part of a k-th main possessed item and a k-th sub possessed item is displayed, and wherein the k-th main possessed item and the k-th sub possessed item are items corresponding to the specific possessed items of the specific player among the k-th main item and the k-th sub item.

As one example, there is provided a server, wherein the process of (I_1) has processes of: (I_1_1) on condition that information on each of the 1-st main item to the n-th main item, information on the at least one 1-st sub item to the at least one n-th sub item and the 1-st hierarchy information to the n-th hierarchy information have been stored and managed in the database, the processor acquiring a request for specific inventory information including information on the specific possessed items of the specific player from the specific user terminal; (I_1_2) the processor (i) transmitting the specific inventory information generated by referring to the information on the specific possessed items to the specific user terminal, and (ii) supporting the specific user terminal to display the specific inventory information through a 2-nd display area and further supporting the specific user terminal to display a first user interface through at least one section in a (2_1)-st display area of the 2-nd display area, wherein the (2_1)-st display area is an area where at least part of a k-th main possessed item and a k-th sub possessed item is displayed, and wherein the k-th main possessed item and the k-th sub possessed item are items corresponding to the specific possessed items of the specific player among the k-th main item and the k-th sub item, and wherein the first user interface is a user interface for acquiring a request for the k-th upgrade tree information from the specific user terminal; and (I_1_3) the processor acquiring a selection signal for the first user interface as a request for the k-th upgrade tree information from the specific user terminal.

As one example, there is provided a server, wherein the process of (I) includes processes of: (I_3) on condition that information on each of the 1-st main item to the n-th main item, information on the at least one 1-st sub item to the at least one n-th sub item and the 1-st hierarchy information to the n-th hierarchy information have been stored and managed in the database, the processor acquiring specific inventory information including information on the specific possessed items of the specific player from the specific user terminal; (I_4) the processor transmitting the specific inventory information generated by referring to information on the specific possessed items of the specific player to the specific user terminal and thus supporting the specific user terminal to display the specific inventory information through a 2-nd display area, and further supporting the specific user terminal to display a 2-nd visual effect through at least one section in a (2_2)-nd display area of the 2-nd display area, wherein the (2_2)-nd display area is an area where a subset of the specific possessed items corresponding to at least part of the (k_1)-st condition and the (k_2)-nd condition among the specific possessed items of the specific player is displayed; and (I_5) the processor supporting a specific user of the specific user terminal to generate at least part of the k-th main upgrade request and the k-th sub upgrade request by referring to information on the subset of the specific possessed items, thereby acquiring at least part of the k-th main upgrade request and the k-th sub upgrade request from the specific user terminal.

As one example, there is provided a server, wherein the process of (I) includes processes of: (I_6) on condition that information on each of the 1-st main item to the n-th main item, information on the at least one 1-st sub item to the at least one n-th sub item and the 1-st hierarchy information to the n-th hierarchy information have been stored and managed in the database, the processor acquiring a request for specific inventory information including information on the specific possessed items of the specific player from the specific user terminal; (I_7) the processor transmitting the specific inventory information generated by referring to the specific possessed items to the specific user terminal and thus supporting the specific user terminal to display the specific inventory information through a 2-nd display area, wherein the server performs at least one of (i) a process of supporting the specific user terminal to display at least part of information on at least one 1-st possessed item satisfying the (k_1)-st condition and at least one 2-nd possessed item satisfying the (k_2)-nd condition among the specific possessed items through a (2_3)-rd display area of the 2-nd display area and (ii) a process of determining the 2-nd possessed item satisfying the (k_2)-nd condition among the specific possessed items of the specific player, and supporting the specific user terminal to display information on the 2-nd possessed item through the (2_3)-rd display area of the 2-nd display area; and (I_8) the processor supporting a specific user of the specific user terminal to generate at least part of the k-th main upgrade request and the k-th sub upgrade request by referring to at least part of information on the 1-st possessed item and information on the 2-nd possessed item, thereby acquiring at least part of the k-th main upgrade request and the k-th sub upgrade request from the specific user terminal.

As one example, there is provided a server, wherein, at the process of (II), on condition that a state of the plurality of players waiting in a waiting space in the battle royale game is a 1-st state, and a state of the plurality of players playing in the battle royale game is a 2-nd state, the processor performs or supports another device to perform at least part of: a 1-st process, in response to determining that the (k_1)-st condition is not satisfied, of (1) increasing a probability of a 1-st non-possessed item being contained in a 1-st supply box to be provided in the 2-nd state by referring to at least part of (i) 1-st specific non-possessed item information necessary for the specific player to satisfy the (k_1)-st condition, (ii) 1-st statistic information on the 1-st specific non-possessed item information and 1-st another non-possessed item information necessary for at least one another player to satisfy the (k-1) -st condition, (iii) at least one player level corresponding to at least part of the specific player and another player and (iv) class information corresponding to the specific player and the another player, and (2) determining a 1-st forwarding position of the 1-st supply box by referring to a position of the specific player and a position of the another player, and a 2-nd process, in response to determining that the (k_2)-nd condition is not satisfied, of (1) increasing a probability of a 2-nd non-possessed item being contained in a 2-nd supply box to be provided in the 2-nd state by referring to at least part of (i) 2-nd specific non-possessed item information necessary for the specific player to satisfy the (k_2)-nd condition, (ii) 2-nd statistic information on the 2-nd specific non-possessed item information and 2-nd another non-possessed item information necessary for the another player to satisfy the (k_2)-nd condition, (iii) the player level corresponding to at least part of the specific player and the another player and (iv) class information corresponding to the specific player and the another player, and (2) determining a 2-nd forwarding position of the 2-nd supply box by referring to the position of the specific player and a position of the another player.

As one example, there is provided a server, wherein the k-th main item includes a (k_1)-th level main item to a (k_mk)-th level main item, and wherein the k-th sub item includes at least part of a (k_1_1)-st sub item directly consumed for upgrading the (k_1)-st level main item and a (k_2_1)-st sub item indirectly consumed for upgrading the (k_1)-st level main item, at least part of a (k_1_2)-nd sub item directly consumed for upgrading the (k_2)-nd level main item and a (k_2_2)-nd sub item indirectly consumed for upgrading the (k_2)-nd level main item, ..., and at least part of a (k_1_ (mk-1) )-th sub item directly consumed for upgrading the (k_(mk-1)) -th level main item and a (k_2_(mk-1)) -th sub item indirectly consumed for upgrading the (k_(mk-1) )-th level main item.

As one example, there is provided a server, wherein, at the process of (I), the processor acquires a (k_jk)-th main upgrade request for upgrading a (k_jk)-th level main item among the (k_1)-st level main item to the (k_mk)-th level main item from the specific user terminal as the k-th main upgrade request, and wherein, at the process of (II), in the main upgrade process, in response to determining that the (k_1)-st condition is satisfied by referring to (i) the specific possessed items, (ii) information on the (k_jk)-th level main item and (k(j+1)k)-th level main item, (iii) information on (k_1_jk)-th sub item and (iv) (k_jk)-th hierarchy information, wherein the (k_jk)-th hierarchy information is information on hierarchy among levels of the (k_jk)-th level main item and (k(j+1)k)-th level main item, information on hierarchy between each of the levels of the (k_jk)-th level main item and each of the levels of the (k_1_jk)-th sub item, and information on hierarchy between each of the levels of the (k_(j+1)k)-th level main item and each of the levels of the (k_1_jk)-th sub item, the server provides the (k_(j+1)k)-th level main item, which is generated by upgrading the (k_jk)-th level main item by using the (k_1_jk)-th sub item, to the specific player.

As one example, there is provided a server, wherein the process of (I) includes processes of: (I_9) on condition that information on each of the 1-st main item to the n-th main item, information on the at least one 1-st sub item to the at least one n-th sub item and the 1-st hierarchy information to the n-th hierarchy information have been stored and managed in the database, acquiring a request for (k_jk)-th upgrade tree information corresponding to (k_jk)-th level main item among the (k_1)-th level main item to the (k_mk)-th level main item from the specific user terminal, wherein the (k_jk)-th upgrade tree information is generated by referring to at least part of (i) information on the (k_jk)-th level main item and (k_(j+1)k)-th level main item, (ii) information on (k_1_jk)-th sub item and (iii) information on hierarchy among levels of the (k_jk)-th level main item and (k(j+1)k)-th level main item, information on hierarchy between each of the levels of the (k_jk)-th level main item and each of the levels of the (k_1_jk)-th sub item, and information on hierarchy between each of the levels of the (k(j+1)k)-th level main item and each of the levels of the (k_1_jk)-th sub item; and (I_10) providing the (k_jk)-th upgrade tree information to the specific user terminal and thus supporting the specific user terminal to generate (k_jk)-th main upgrade request for upgrading the (k_jk)-th level main item by referring to the (k_jk)-th upgrade tree information, thereby acquiring the (k_jk)-th main upgrade request from the specific user terminal as the k-th main upgrade request.

As one example, there is provided a server, wherein at the process of (I_10), the processor provides the (k_jk)-th upgrade tree information to the specific user terminal and thus supports the specific user terminal to display the (k_jk)-th upgrade tree information through a 1-st display area, thereby supporting the specific user terminal to generate the (k_jk)-th main upgrade request for upgrading the (k_jk)-th level main item, wherein the processor further supports the specific user terminal to display a 3-rd visual effect through at least one section in a (1_2)-nd display area of the 1-st display area, wherein the (1_2)-nd display area is an area where at least part of a specific k-th lower level item is displayed, and wherein the specific k-th lower level item is at least one of (i) at least part of a (k_1_1)-st sub item directly consumed for upgrading the (k_1)-st level main item and a (k-2-1)-st sub item indirectly consumed for upgrading the (k_1)-st level main item, at least part of a (k_1_2)-nd sub item directly consumed for upgrading the (k_2)-nd level main item and a (k_2_2)-nd sub item indirectly consumed for upgrading the (k_2)-nd level main item, ..., and at least part of a (k_1_(jk-1))-st sub item directly consumed for upgrading the (k_(jk-1))-st level main item and a (k_2_(jk-1))-st sub item indirectly consumed for upgrading the (k_(jk-1))-st level main item, and (ii) an item of the (k_1)-st level main item to the (k_(jk-1))-st level main item.

### BRIEF DESCRIPTION OF THE DRAWINGS

The accompanying drawings used to explain example embodiments of the present disclosure are only part of example embodiments of the present disclosure and other drawings can be obtained based on the drawings by those skilled in the art of the present disclosure without inventive work.

FIG. 1 is a drawing representing a schematic illustration of a server for providing a battle royale game which allows items to be upgraded in accordance with one example embodiment of the present invention.

FIG. 2 is a drawing representing a flowchart for explaining processes of providing the battle royale game which allows the items to be upgraded in accordance with one example embodiment of the present invention.

FIG. 3A to FIG. 3C are drawings representing schematic illustrations of upgrade tree information provided to a user terminal in accordance with one example embodiment of the present invention.

FIG. 4 is a drawing representing a schematic illustration of inventory information provided to the user terminal in accordance with one example embodiment of the present invention.

FIG. 5A and FIG. 5B are drawings representing schematic illustrations of information on upgrading displayed through the user terminal in accordance with one example embodiment of the present invention.

### DETAILED DESCRIPTION OF THE PREFERRED EMBODIMENTS

In the following detailed description, reference is made to the accompanying drawings that show, by way of illustration, specific embodiments in which the invention may be practiced. These embodiments are described in sufficient detail to enable those skilled in the art to practice the invention.

Besides, in the detailed description and claims of the present disclosure, a term “include” and its variations are not intended to exclude other technical features, additions, components or steps. Other objects, benefits and features of the present disclosure will be revealed to one skilled in the art, partially from the specification and partially from the implementation of the present disclosure. The following examples and drawings will be provided as examples but they are not intended to limit the present disclosure.

Furthermore, the present invention includes all possible combinations of embodiments indicated in the present disclosure. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

Hereinafter, to allow those skilled in the art to the present disclosure to be carried out easily, the example embodiments of the present disclosure by referring to attached diagrams will be explained in detail as shown below.

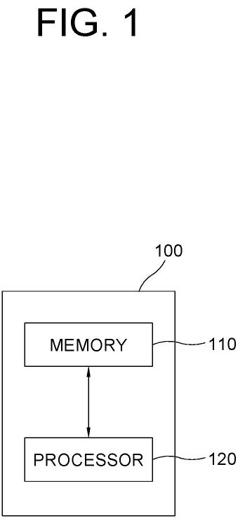

FIG. 1 is a drawing representing a schematic illustration of a server 100 for providing a battle royale game which allows items to be upgraded in accordance with one example embodiment of the present invention, and referring to FIG. 1, the server 100 may include a memory 110 that stores instructions for providing the battle royale game which allows the items to be upgraded, and a processor 120 configured to execute the instructions stored in the memory 110 to perform or support another device to perform operations for providing the battle royale game.

Specifically, the server 100 may typically achieve a desired system performance by using combinations of at least one computing device and at least one computer software, e.g., a computer processor, a memory, a storage, an input device, an output device, or any other conventional computing components, an electronic communication device such as a router or a switch, an electronic information storage system such as a network-attached storage (NAS) device and a storage area network (SAN) as the computing device and any instructions that allow the computing device to function in a specific way as the computer software.

Also, the processors of such devices may include hardware configuration of MPU (Micro Processing Unit) or CPU (Central Processing Unit), cache memory, data bus, etc. Additionally, the computing device may further include operating system (OS) and software configuration of applications that achieve specific purposes.

Such description of the computing device does not exclude an integrated device including any combination of a processor, a memory, a medium, or any other computing components for implementing the present disclosure.

The method for providing the battle royale game which allows the items to be upgraded in accordance with one example embodiment of the present invention using the server 100 configured as above is explained below.

For reference, assuming that (i) a state of any one class among a 1-st class to an n-th class being assigned to at least part of a plurality of player groups and at least part of a plurality of players belonging to the plurality of player groups waiting in a waiting space in the battle royale game is a 1-st state, and (ii) a state of the plurality of players playing in the battle royale game is a 2-nd state, the embodiments explained below can be performed in at least one state of the 1-st state and the 2-nd state.

Herein, the class may correspond to a kind of a job applied to the players.

Specifically explaining, in a conventional battle royale game, physical abilities of the players are all the same, and thus the survival strategy was mainly determined according to what items (for example, weapons or protective items) are possessed by the player, whereas the server 100 in accordance with one example embodiment of the present invention provides each of classes, its corresponding class perk which is a unique ability, its corresponding class ultimate skill and its corresponding class synergetic item, thereby supporting the players to establish various strategies/tactics in light of its corresponding class perk, its corresponding class ultimate skill and its corresponding class synergetic item and class synastry, etc. owned by the player controlled.

In addition, unlike the conventional battle royale game, the server 100 in accordance with one example embodiment of the present invention supports the players to upgrade items of lower level acquired in the field to items of upper level, and supports the players to disassemble the items of upper level to acquire the items of lower level, thereby supporting the players to establish various strategies/tactics for survival to the end in a restricted space in the same game.

Specifically explaining, in the conventional battle royale game, the items that can be used in a battle were limited, and thus the players were able to collect the items that can be used in the battle easily in an initial stage. Accordingly, after the initial stage, necessary items already have been collected to some extent, and thus the players of the conventional battle royale game played mainly in the manner of staying in a safe place while moving as little as possible in order to reduce the risk of failure in the survival competition as much as possible due to accidental battles that can occur outside of the safe place.

However, according to the above manner of play, the players may become excessively get rigid, and thus as explained above, there has been a problem that the players easily lose interest in the game, and the lifespan of the game is shortened.

In contrast, the server 100 in accordance with one example embodiment of the present invention supports the players to upgrade the items of lower level to the items of upper level, and such upgraded items can have better performance than the items of lower level.

For example, a weapon of upper level generated by upgrading a weapon of lower level may possess a special skill, or may have increased attacking force/range/stability/continuous firing speed/number of bullets, etc.

Accordingly, the server 100 in accordance with one example embodiment of the present invention may induce the players playing in the manner of steadily collecting the items even after the initial stage of the game and upgrading the items to have a definite advantage over the competitors playing in the manner of staying in the safe place after collecting the items in the initial stage.

In addition, as the players are induced to actively move, the frequency of occurrence of battles also increases, and this may impart interest and tension continuously to the users playing the battle royale game.

Meanwhile, the term “upgrade” described in the present disclosure is a concept similar to “produce” or “enhance,” etc., and for convenience, throughout the specification and the drawings, “produce,” “enhance” and “upgrade” are interchangeably described.

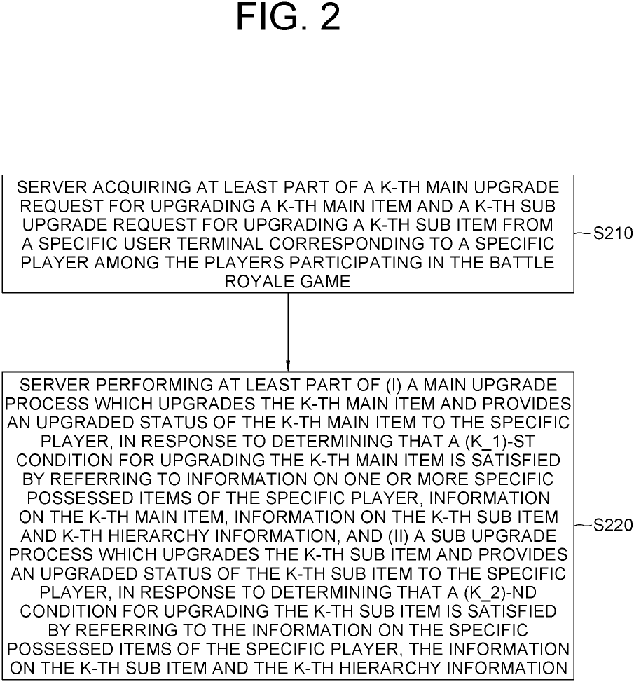

FIG. 2 is a drawing representing a flowchart for explaining processes of providing a battle royale game in which items are upgraded by the server 100 in accordance with one example embodiment of the present invention.

Referring to FIG. 2, the server 100 in accordance with one example embodiment of the present invention may acquire at least part of a k-th main upgrade request for upgrading a k-th main item and a k-th sub upgrade request for upgrading a k-th sub item from a specific user terminal corresponding to a specific player among the players participating in the battle royale game at a step of S210. For reference, k may be any one integer among 1 to n and n may be an integer equal to or larger than 1.

In addition, the server 100 may perform at least part of (i) a main upgrade process which upgrades the k-th main item and provides an upgraded status of the k-th main item to the specific player, in response to determining that a (k_1)-st condition for upgrading the k-th main item is satisfied by referring to information on one or more specific possessed items of the specific player, information on the k-th main item, information on the k-th sub item and k-th hierarchy information, wherein the k-th hierarchy information is information on hierarchy among levels of the k-th main item, information on hierarchy among levels of the k-th sub item, and information on hierarchy between each of the levels of the k-th main item and each of the levels of the k-th sub item, and (ii) a sub upgrade process which upgrades the k-th sub item and provides an upgraded status of the k-th sub item to the specific player, in response to determining that a (k_2)-nd condition for upgrading the k-th sub item is satisfied by referring to the information on the specific possessed items of the specific player, the information on the k-th sub item and the k-th hierarchy information at a step of S220.

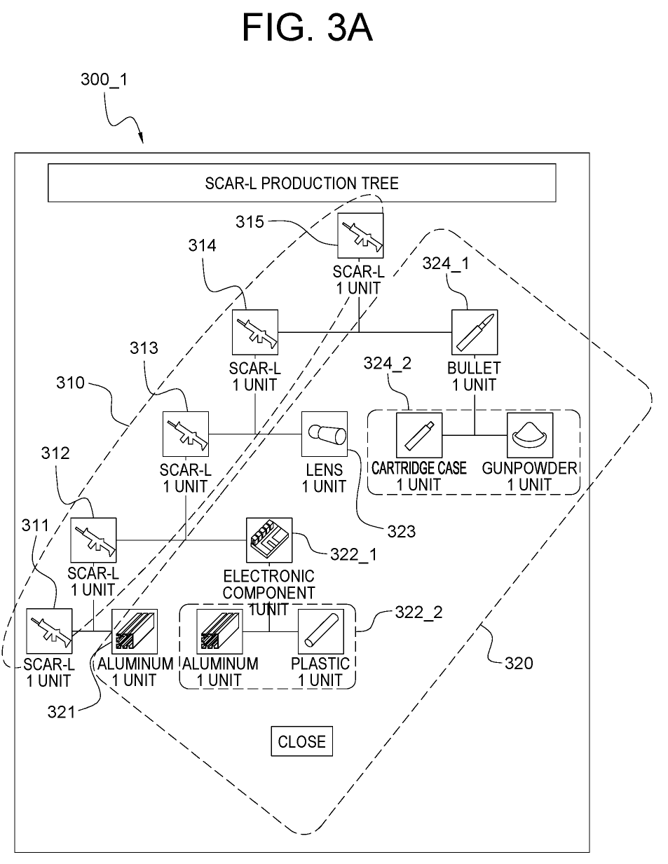

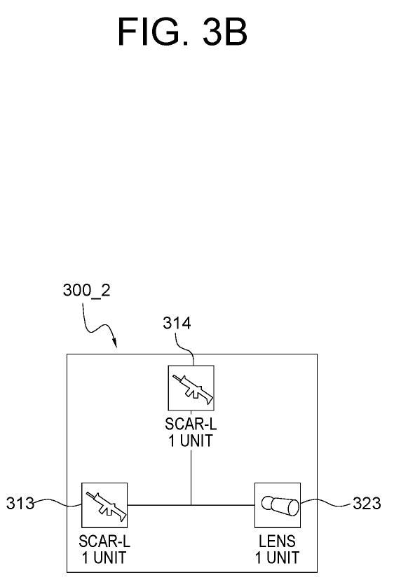

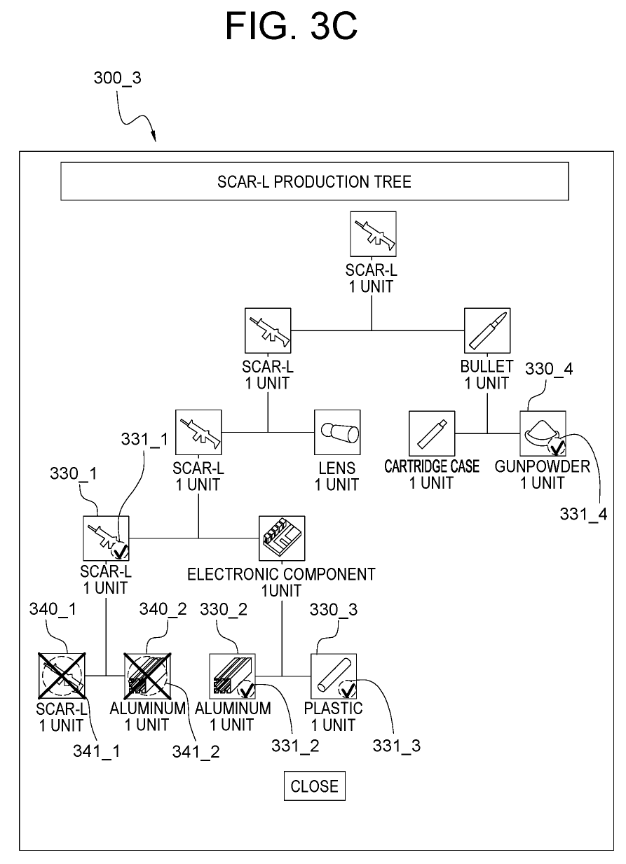

FIG. 3A to FIG. 3C are drawings representing schematic illustrations of upgrade tree information provided to a user terminal in accordance with one example embodiment of the present invention.

Firstly, we can assume that the database has stored and managed information on a 1-st main item to an n-th main item, information on a 1-st sub item to an n-th sub item corresponding to the 1-st main item to the n-th main item and 1-st hierarchy information to n-th hierarchy information.

Herein, the 1-st main item to the n-th main item may be items such as weapon items (for example, “M16,” “KGS-12,” “P90,” “machete,”) protective items (for example, “Stahlhelm,” “90’s helmet,” “EOD suit”) , supporting items (for example, “backpack,” “duffel bag,” “jet suit,” “ski”), that the player can wear.

For example, the 1-st main item may be “M16,” a 2-nd main item may be “KGS-12,” a 3-rd main item may be “jet suit,” a 4-th main item may be “EOD suit,” ..., and the n-th main item may be “P90.”

In addition, each of the 1-st sub item to the n-th sub item to be consumed respectively for upgrading each of the 1-st main item to the n-th main item may include at least part of (i) each of a (1_1) -st sub item to an (n_1) -st sub item directly consumed respectively for upgrading each of the 1-st main item to the n-th main item and (ii) each of a (1_2)-nd sub item to an (n_2)-nd sub item indirectly consumed respectively for upgrading the 1-st main item to the n-th main item.

For example, the 1-st sub item to the n-th sub item may include material items such as “plastics” and “aluminum.”

However, it is not limited thereto, and the main items explained above may also be used as sub items depending on the case.

For example, if “M16” which is the 1-st main item can be upgraded by consuming “P90” which is the n-th main item, then “P90” may be the 1-st sub item for upgrading the 1-st main item.

In addition, each of the 1-st hierarchy information to the n-th hierarchy information may include each of information on hierarchy among levels of the 1-st main item to information on hierarchy among levels of the n-th main item, each of information on hierarchy among levels of the 1-st sub item to information on hierarchy among levels of the n-th sub item, and each of information on hierarchy between each of the levels of the 1-st main item and each of the levels of the 1-st sub item to information on hierarchy between each of the levels of the n-th main item and each of the levels of the n-th sub item.

In addition, the k-th main item which is at least part of the 1-st main item to the n-th main item may include a (k_1)-th level main item to a (k_mk)-th level main item. For reference, mk may be an integer of 1 or more.

Referring to FIG. 3A in order to facilitate understanding, for example, when the k-th main item is SCAR-L 310, SCAR-L 310 may include 1-star SCAR-L 311 as the (k_1)-st level main item, 2-star SCAR-L 312 as the (k_2)-nd level main item, 3-star SCAR-L 313 as the (k_3)-rd level main item, 4-star SCAR-L 314 as the (k_4)-th level main item and 5-star SCAR-L 315 as the (k_5)-th level main item.

In addition, the server 100 may support the users to view what items correspond to the items of upper level by indicating each cardinal number of star-shaped figure behind each name of each item of each level, indicating the hue of each name of each item differently, or giving more splendid visual effect for the items of upper level.

As one example, the k-th sub item among the 1-st sub item to the n-th sub item may include at least part of a (k_1_1)-st sub item directly consumed for upgrading the (k_1)-st level main item and a (k_2_1)-st sub item indirectly consumed for upgrading the (k_1) -st level main item, at least part of a (k_1_2)-nd sub item directly consumed for upgrading the (k_2)-nd level main item and a (k_2_2)-nd sub item indirectly consumed for upgrading the (k_2)-nd level main item, ..., and at least part of a (k_1_(mk-1))-th sub item directly consumed for upgrading the (k (mk-1))-th level main item 314 and a (k_2_(mk-1))-th sub item indirectly consumed for upgrading the (k_(mk-1))-th level main item 314.

Further, by referring to FIG. 3A again in order to facilitate understanding, for example, the k-th sub item 320 may include aluminum 321 which is the (k_1_1)-st sub item directly consumed for upgrading the 1-star SCAR-L 311 which is the (k_1)-st level main item, an electronic component 322_1 which is (k_1_2)-nd sub item directly consumed for upgrading the 2-star SCAR-L 312 which is (k_2)-nd level main item, aluminum and plastic 322_2 which are the (k_2_2)-nd sub items indirectly consumed for upgrading the 2-star SCAR-L 312 which is the (k_2)-nd level main item, lens 323 which is the (k_1_3)-rd sub item directly consumed for upgrading the 3-star SCAR-L 313 which is (k_3)-rd level main item, a bullet 324_1 which is the (k_1_4)-th sub item directly consumed for upgrading the 4-star SCAR-L 314 which is the (k_4) -th level main item and a cartridge case and gunpowder 324_2 which are the (k_2_4)-th sub item indirectly consumed for upgrading the 4-star SCAR-L 314 which is the (k_4)-th level main item.

Meanwhile, the k-th hierarchy information among the 1-st hierarchy information to the n-th hierarchy information may include information on hierarchy among the levels of the k-th main item, information on hierarchy among the levels of the k-th sub item, and information on hierarchy between each of the levels of the k-th main item and each of the levels of the k-th sub item.

Further, by referring to FIG. 3A again, for example, the k-th hierarchy information may include hierarchy information (i) among the 2-star SCAR-L 312 and the 3-star SCAR-L 313, (ii) among the electronic component 322_1 directly consumed and the aluminum and plastic 322_2 indirectly consumed, for upgrading the 2-star SCAR-L 312 and (iii) between the level of the 2-star SCAR-L 312 or the level of the 3-star SCAR-L 313 and the level of the electronic part 322_1.

For reference, in the above, for convenience of explanation, the 2-star SCAR-L was explained for example, but the present invention is not limited thereto.

Meanwhile, a manner of the server 100 in accordance with one example embodiment of the present invention acquiring at least part of the main upgrade request and the sub upgrade request from the specific user terminal may be various. For example, the server 100 may (i) acquire at least part of the main upgrade request and the sub upgrade request through a manner of pressing a specific shortcut key (for example, entering “ctrl+c” through a keyboard), (ii) acquire a selection signal for a specific item in a screen, in which inventory information or upgrade tree information is displayed, as at least part of the main upgrade request and the sub upgrade request, or (iii) acquire a signal representing that a cursor is positioned in an area of a screen, in which a specific item is displayed, as at least part of the main upgrade request and the sub upgrade request. Meanwhile, this is merely an example to facilitate understanding for convenience, and the present invention is not limited thereto.

Specifically, in case the server 100 acquires a (k_jk) -th main upgrade request for upgrading a (k_jk)-th level main item among the (k-1)-st level main item 311 to the (k_mk)-th level main item 315 from the specific user terminal as the k-th main upgrade request, in response to determining that the (k_1)-st condition is satisfied by referring to (i) the specific possessed items, i.e., items owned by the specific user, (ii) information on the (k_jk)-th level main item and (k_(j+1)k)-th level main item, (iii) information on (k_l_jk)-th sub item and (iv) (k_jk)-th hierarchy information, wherein the (k_jk)-th hierarchy information includes at least part of information on hierarchy among levels of the (k_jk)-th level main item and (k_(j+1)k)-th level main item, information on hierarchy between each of the levels of the (k_jk)-th level main item and each of the levels of the (k_1_jk)-th sub item, and information on hierarchy between each of the levels of the (k_(j+1)k)-th level main item and each of the levels of the (k_1_jk)-th sub item, the server may provide the (k_(j+1) k)-th level main item, which is generated by upgrading the (k_jk)-th level main item by using the (k_1_jk)-th sub item, to the specific player. For reference, jk may be an integer of 1 to mk.

Referring to FIG. 3A again, explaining a case where the (k_jk)-th main upgrade request for upgrading the 2-star SCAR-L 312 is acquired for example, the server 100 may confirm that one 2-star SCAR-L 312 and one electronic component 322_1 are necessary for upgrading the 2-star SCAR-L 312 by referring to (i) information on the 2-star SCAR-L 312, the 3-star SCAR-L 313, (ii) information on the electronic component 322_1, (iii) the hierarchy information among the 2-star SCAR-L 312 and the 3-star SCAR-L 313, between the 2-star SCAR-L 312 and the electronic component, and between the 3-star SCAR-L 313 and the electronic component 322_1. In addition, the server 100 confirms whether a specific player possesses the 2-star SCAR-L 312 and the electronic component 322_1, and in response to confirming that the specific player possesses the 2-star SCAR-L 312 and the electronic component 322_1, the server may determine that the (k_1)-st condition is satisfied and generate the 3-star SCAR-L 313 by upgrading the 2-star SCAR-L 312, e.g., by consuming one electronic component 322_1.

In addition, the description explained above can be applied identically or similarly also to the sub upgrade process.

As one example, in case an upgrade request for aluminum or plastic 322_2 which is the (k_2_2)-nd sub item has been acquired, in response to determining that the specific player possesses one aluminum and one plastic 322_2 indirectly consumed for upgrading 2-star SCAR-L 312 as the (k_2)-nd condition, the server 100 may provide (to the specific player) the electronic component 322_1 generated by consuming one aluminum and one plastic 322_2, by referring to information on each of sub items and the hierarchy information corresponding thereto.

Meanwhile, as described above, an item of upper level may possess a special skill, or may have better performance such as increased attacking force/range/stability/continuous firing speed/number of bullets, etc. For example, the 1-star SCAR-L may be set to have the performance of the attacking force 10, the range 100, the stability 20, the continuous firing speed 20, and the 2-star SCAR-L may be set to have the performance of the attacking force 15, the range 120, the stability 20, the continuous firing speed 20, and be stored and managed in the database.

In addition, the server 100 in accordance with one example embodiment of the present invention may allow a perk to be added to the main item being upgraded.

As one example, the server 100 may set the main items having levels of 1-star to 5-star to have probabilities of the perk being added to correspond to the respective main upgrade steps for the main items.

For example, the server 100 may set (i) the probability of any perk being added when upgrading the main item from 1-star to 2-star to be 10%, (ii) the probability of any perk being added when upgrading the main item from 2-star to 3-star to be 30%, (iii) the probability of any perk being added when upgrading the main item from 3-star to 4-star to be 80%, (iv) the probability of any perk being added when upgrading the main item from 4-star to 5-star to be 90%.

However, the present invention is not limited thereto, and the server 100 may set the probabilities of the perk being added according to their corresponding main upgrade steps by further referring to information on the situation of game progress explained above (for example, “information that the point in time is 15 minutes after the battle royale game has started,” “information that 50% or more of the players among the total players possess an item of 3-star or higher,” “information that the specific player who made the upgrade request has just the 1-star SCAR-L,” “the items spawned near the specific player are all just the 1-star items, and there are no sub items for upgrading the 2-star SCAR-L,” etc.).

Meanwhile, the server 100 in accordance with one example embodiment of the present invention may provide the upgrade tree information to the specific user terminal and thus support the specific user terminal to generate at least part of the main upgrade request and the sub upgrade request, and various embodiments are explained below.

As one example, the server 100 in accordance with one example embodiment of the present invention may acquire a request for k-th upgrade tree information corresponding to the k-th main item from the specific user terminal.

Herein, the k-th upgrade tree information may be generated by referring to at least part of information on the k-th main item, information on the k-th sub item and the k-th hierarchy information.

In addition, the server 100 may provide the k-th upgrade tree information to the specific user terminal and thus support the specific user terminal to generate at least part of the k-th main upgrade request for upgrading the k-th main item and the k-th sub upgrade request for upgrading the k-th sub item by referring to the k-th upgrade tree information, thereby acquiring at least part of the k-th main upgrade request and the k-th sub upgrade request from the specific user terminal.

As one example, assuming the specific player possesses the 2-star SCAR-L 312, one aluminum 322_2 and one lens 323, upon referring to FIG. 3A illustrating the upgrade tree information 300_1 for SCAR-L again, the specific user can confirm what is necessary and what to do in order to upgrade the 2-star SCAR-L by referring to the k-th upgrade tree (for example, the upgrade tree information for SCAR-L) provided by the server 100.

That is, the specific user can confirm that (i) one electronic component 322_1 is necessary to upgrade the 2-star SCAR-L 312, and (ii) one aluminum and one plastic 322_2 are necessary to produce the electronic component 322_1 by referring to upgrade tree information 300_1 for the SCAR-L.

In addition, the specific player already possesses the 2-star SCAR-L 312, one aluminum 322_2 and one lens 323, and thus the specific user can confirm that only one more plastic 322_2 should be acquired to upgrade the 2-star SCAR-L 312 to the 4-star SCAR-L 314.

Accordingly, the specific user may establish a strategy of setting the acquisition of one more plastic 322_2 as the first priority.

As explained above, the server 100 in accordance with one example embodiment of the present invention may provide upgrade tree information to the specific user terminal and thus may support the specific user terminal to generate at least part of the main upgrade request and the sub upgrade request by referring to the upgrade tree information.

As one example, in case the server 100 acquires a request for (k_jk)-th upgrade tree information corresponding to (k_jk)-th level main item among the (k_1)-th level main item to the (k_mk)-th level main item from the specific user terminal, the server 100 may generate the (k_jk)-th upgrade tree information by referring to at least part of (i) information on the (k_jk)-th level main item and (k_(j+1)k)-th level main item, (ii) information on (k_1_jk)-th sub item and (iii) information on hierarchy among levels of the (k_jk)-th level main item and (k_(j+1)k)-th level main item, information on hierarchy between each of the levels of the (k_jk)-th level main item and each of the levels of the (k_1_jk)-th sub item, and information on hierarchy between each of the levels of the (k(j+1)k)-th level main item and each of the levels of the (k_1_jk)-th sub item, and then provide the (k_jk)-th upgrade tree information to the specific user terminal, thereby supporting the specific user terminal to generate at least part of the (k_jk)-th main upgrade request and the (k_jk)-th sub upgrade request by referring to the (k_jk)-th upgrade tree information.

For reference, in response to acquiring a request for the upgrade tree information on the 3-star SCAR-L 313 as the (k_jk)-th level main item, the server 100 in accordance with one example embodiment of the present invention (i) may provide total upgrade tree information 300_1 on SCAR-L as shown in FIG. 3B, but it is not limited thereto, (ii) as shown in FIG. 3B, may provide a part of the upgrade tree information on the SCAR-L, i.e., (i) information on the 3-star SCAR-L 313 and the 4-star SCAR-L 314, (ii) the lens 323 which is the (k_1_jk)-th sub item, and (iii) hierarchy information between the 3-star SCAR-L 313 and the 4-star SCAR-L 314, between the 3-star SCAR-L 313 and the lens 323, between the 4-star SCAR-L 314 and the lens 323.

For reference, the upgrade tree information 300_1 in FIG. 3A shows the total upgrade tree information on a main item, and thus it may be helpful to the specific user in establishing a long term strategy for collecting sub items and upgrading the main item and/or the sub items, and partial upgrade tree information 300_2 shown in FIG. 3B may be helpful to the specific user for quickly checking what sub item is immediately necessary.

As one example, the server 100 in accordance with one example embodiment of the present invention may support users to set which upgrade information is to be provided between the total upgrade tree information 300_1 and the partial upgrade tree information 300_2.

As another example, the server 100 may allow the partial upgrade tree information 300_2 corresponding to the main item currently equipped on the specific player to be displayed in an area which is part of the display area of the specific user terminal.

Meanwhile, the server 100 in accordance with one example embodiment of the present invention may allow the specific user terminal to display the upgrade tree information through a 1-st display area. Herein, the server 100 may further support the specific user terminal to display a 1-st visual effect through at least one section in a (1_1)-st display area of the 1-st display area. Herein, the (1_1)-st display area is an area where a main possessed item and a sub possessed item are displayed.

For example, in case the specific player currently possesses 2-star SCAR-L, aluminum, plastic and gunpowder, as shown in FIG. 3C, the server 100 may further support the specific user terminal to display the 1-st visual effect (for example, “v” mark) through some sections 331_1, 331_2, 331_3, 331_4 in the (1_1)-st display area 330_1, 330_2, 330_3, 330_4. Herein, the (1_1)-st display area is an area where each of the 2-star SCAR-L, the aluminum, the plastic and the gunpowder is displayed.

That is, through the 1-st visual effect, the server 100 may support the users to quickly check (i) what the necessary item is or (ii) what material is sufficiently possessed for upgrading, etc.

For reference, for convenience, in FIG. 3C, “v” mark is displayed as the 1-st visual effect, but it is not limited thereto, and a visual effect having a different form/shape/color may be displayed.

Meanwhile, the server 100 in accordance with one example embodiment of the present invention may further support the specific user terminal to provide the upgrade tree information with a 3-rd visual effect through at least one section in a (1_2)-nd display area of the 1-st display area.

For reference, the (1_2)-nd display area 340_1, 340_2 may be at least one area where at least part of a specific k-th lower level item is displayed. Herein, the specific k-th lower level item is at least one of (i) at least part of a (k_1_1)-st sub item directly consumed for upgrading the (k_1)-st level main item and a (k_2_1)-st sub item indirectly consumed for upgrading the (k_1)-st level main item, at least part of a (k_1_2)-nd sub item directly consumed for upgrading the (k_2)-nd level main item and a (k_2_2)-nd sub item indirectly consumed for upgrading the (k_2)-nd level main item, ..., and at least part of a (k_1_(jk-1))-st sub item directly consumed for upgrading the (k_(jk-l))-st level main item and a (k_2_(jk-1))-st sub item indirectly consumed for upgrading the (k_(jk-1))-st level main item, and (ii) the (k_1)-st level main item to the (k_(jk-1))-st level main item.

For example, in case the specific player currently possesses the 2-star SCAR-L, (i) information on the 1-star SCAR-L and (ii) information on the material for upgrading the 1-star SCAR-L (for example, the aluminum), are information on any main item of lower level whose level is lower than the 2-star SCAR-L which the specific player already possesses, and information on the sub items corresponding to said any main item of lower level, and thus it may not be important to the specific user.

Accordingly, as shown in FIG. 3C, the server 100 may further support the specific user terminal to display the 3-rd visual effect (for example, “X” mark) through at least one section 341_1, 341_2 of the (1_2)-nd display area 340_1, 340_2. Herein, the (1_2)-nd display area may be at least one area where the 1-star SCAR-L or one aluminum for upgrading the 1-star SCAR-L is displayed.

That is, through the 3-rd visual effect, the server 100 may support the users to quickly check what item is not necessary for upgrading.

For reference, for convenience, in FIG. 3C, “X” mark is displayed as the 3-rd visual effect, but it is not limited thereto, and the 3-rd visual effect may be further displayed through various manners such as the area concerned becoming dark, etc.

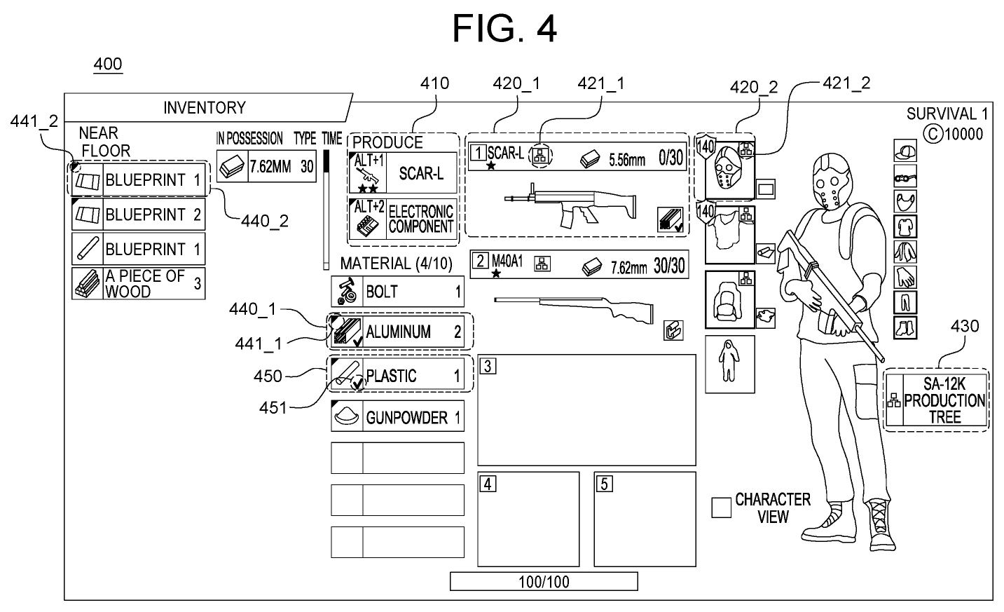

Meanwhile, referring to FIG. 4, it is explained below as to the inventory information that the server 100 provides to the specific user terminal.

FIG. 4 is a drawing representing a schematic illustration of the inventory information provided to the user terminal by the server in accordance with one example embodiment of the present invention.

Referring to FIG. 4, in response to acquiring a request for specific inventory information including information on the specific possessed items of the specific player from the specific user terminal, the server 100 in accordance with one example embodiment of the present invention may (i) transmit the specific inventory information generated by referring to the information on the specific possessed items to the specific user terminal, and (ii) support the specific user terminal to display the specific inventory information through the 2-nd display area and support the specific user terminal to further display a user interface (for acquiring a request for the upgrade tree information) through at least one section in a (2_1)-st display area of the 2-nd display area, thereby acquiring a selection signal through the user interface as a request for the k-th upgrade tree information from the specific user terminal.

For reference, the specific inventory information displayed through the 2-nd display area 400 may include information on the specific possessed items of the specific player, but it is not limited thereto, and also may further include information on items located near the specific player. For example, referring to FIG. 4 again, it can be confirmed that the information on the items near the specific player (for example, “blueprint,” “a piece of wood”, etc.) is displayed through a partial display area marked with “near” in the 2-nd display area 400. Herein, the 2-nd display area is the area where the specific inventory information is displayed.

In addition, the (2_1)-st display area is an area where at least part of the main possessed item and the sub possessed item is displayed, and the main possessed item and the sub possessed item may be the specific possessed items of the specific player among the main items and the sub items. For example, referring to FIG. 4 again, the specific player possesses the 1-star SCAR-L as the main item, and thus it can be confirmed that the 1-star SCAR-L is displayed in the (2_1)-st display area 420_1.

In addition, as shown in FIG. 4, the server 100 may further provide a user interface for requesting the upgrade tree information in at least one section of the (2_1)-st display area, wherein the (2_1)-st display area is an area where the 1-star SCAR-L is displayed, and thus may allow the users to easily request the upgrade tree information.

For reference, the user interface for requesting the upgrade tree information may be displayed inside or near the area where the main item currently equipped on the specific player is displayed, but the present invention is not limited thereto.

As one example, the user interface for requesting the upgrade tree information may be displayed inside or near the area where the main item which is not currently equipped on the specific player is displayed. For example, as shown in FIG. 4, the user interface 430 for requesting the upgrade tree information on the item which is not currently possessed by the specific player (for example, SA-12K) may be displayed.

For reference, the user interface 430 for requesting the upgrade tree information regarding an item which is not currently possessed by the specific player (for example, SA-12K) may be a user interface for requesting the upgrade tree information regarding (i) a synergetic item capable of demonstrating higher performance in the case of being used by the specific player who is imparted with the specific class, or (ii) an item capable of demonstrating highest efficiency for the specific player in the current situation.

Meanwhile, in response to acquiring the request for the specific inventory information from the specific user terminal, the server 100 in accordance with one example embodiment of the present invention may support the specific user terminal to display the specific inventory information through the 2-nd display area, support the specific user terminal to further display the 2-nd visual effect through at least one section in a (2_2)-nd display area of the 2-nd display area, and support the specific user of the specific user terminal by referring to information on the specific possessed item, thereby acquiring at least part of the k-th main upgrade request and the k-th sub upgrade request from the specific user terminal.

For reference, the (2_2)-nd display area may be an area where the specific possessed item corresponding to at least part of the (k_1)-st condition and the (k_2)-nd condition among the possessed items of the specific player.

For example, in case one aluminum is necessary to upgrade the 1-star SCAR-L, as shown in FIG. 4, in order to inform the specific user to easily confirm that aluminum is the necessary material for upgrading the 1-star SCAR-L, the server 100 may further display the 2-nd visual effect (for example, mark with yellow right-angled triangle) through at least one section 440_2 of the (2_2) -nd display area 440_1, wherein the (2_2)-nd display area is an area where the aluminum is displayed.

As another example, the server 100 may further support the specific user terminal to display the 2-nd visual effect as to the item which is not currently possessed by the specific player. For example, in case a blueprint is necessary to upgrade the 1-star SCAR-L, as shown in FIG. 4, the server 100 may further display the 2-nd visual effect (for example, mark with yellow right-angled triangle) through at least one section 441_2 of the 2_2-nd display area 440_2, wherein the 2_2-nd display area 440_2 is where the blueprint is displayed.

Accordingly, the server 100 may (i) support the specific user terminal to display the 2-nd visual effect on the possessed item currently possessed by the specific player among the items necessary for upgrading, thereby preventing the situation of abandoning the possessed item necessary for upgrading by mistake, and (ii) support the specific user terminal to display the 2-nd visual effect on another item which is not currently possessed by the specific player, thereby allowing the specific player to quickly check what item is necessary for upgrading.

Meanwhile, the server 100 in accordance with one example embodiment of the present invention may support the specific user terminal to display the specific inventory information through the 2-nd display area, and further support the specific user terminal to display a 4-th visual effect in at least one section of a (2_4)-th display area of the 2-nd display area.

Herein, the (2_4)-th display area may be an area where a specific sub item satisfying the condition of necessary quantity for upgrading among the necessary sub items for upgrading a main item currently possessed by the specific player.

For example, assuming that one plastic is necessary to upgrade the 1-star SCAR-L among the main items and assuming that the plastic is not necessary to upgrade the other main items, referring to FIG. 4 again, the specific player currently possesses one plastic, and thus it can be understood that the condition for the type (i.e., plastic) and the number (i.e., one) of the material for upgrading the 1-star SCAR-L is satisfied. Accordingly, the server 100 may further support the specific user terminal to display the 4-th visual effect (for example, “v” mark) through at least one section 451 of the (2_4)-th display area 450, wherein the (2_4)-th display area 450 is an area where the plastic is displayed.

That is, the 2-nd visual effect is displayed as to what item is necessary for upgrading, thereby supporting the specific user to quickly determine what item is to be collected among the items located near the specific player or supporting the specific user to quickly determine what item is to be abandoned, whereas the 4-th visual effect informs the specific user that the sufficient number has been secured as much as necessary for upgrading, and thus prevent the specific user from collecting unnecessary items.

For example, it is assumed that one identical sub item is necessary to upgrade 1-star M40A1 and 1-star SCAR-L for each, and it is assumed that the specific player currently possesses only 1 sub item at issue. In such a case, the number of the sub item at issue is not sufficient to upgrade the total main possessed items possessed by the specific player, and thus the 4-th visual effect would not be displayed for the sub item at issue. Accordingly, the server 100 may support users to easily check what material is sufficient to upgrade the main item(s) .

Meanwhile, in response to acquiring a request for the specific inventory information from the specific user terminal, the server 100 in accordance with one example embodiment of the present invention may support the specific user terminal to display the specific inventory information through the 2-nd display area, and may perform at least one of (i) a process of supporting the specific user terminal to display at least part of information on at least one 1-st possessed item satisfying the (k_1)-st condition and at least one 2-nd possessed item satisfying the (k_2)-nd condition among the specific possessed items through a (2_3)-rd display area of the 2-nd display area and (ii) a process of determining the 2-nd possessed item satisfying the (k_2)-nd condition among the specific possessed items of the specific player, and supporting the specific user terminal to display information on the 2-nd possessed item through the (2_3)-rd display area of the 2-nd display area, thereby supporting the specific user terminal to refer to at least part of information on the 1-st possessed item and information on the 2-nd possessed item and then acquiring at least part of the k-th main upgrade request and the k-th sub upgrade request from the specific user terminal.

For example, it is assumed that one 1-star SCAR-L and one aluminum are necessary to upgrade the 1-star SCAR-L to the 2-star SCAR-L, and one aluminum and one plastic are necessary to upgrade the aluminum and the plastic to an electronic component. Referring to FIG. 4 again, the specific player possesses one 1-star SCAR-L, two aluminums and one plastic, and thus it can be confirmed that all the conditions for upgrading to the 2-star SCAR-L and the electronic component are satisfied. Accordingly, the server 100 in accordance with one example embodiment of the present invention may support the specific user terminal to display information on the 2-star SCAR-L and the electronic component (which is not possessed yet, but which can be upgraded/produced immediately by using the items currently in possession) through the “produce” area which is the (2_3)-display area 410.

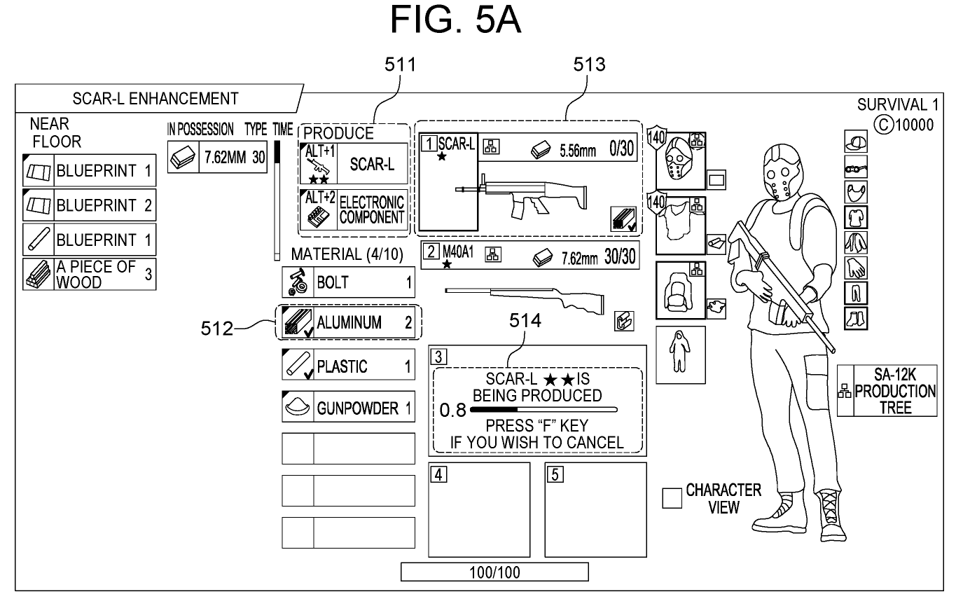

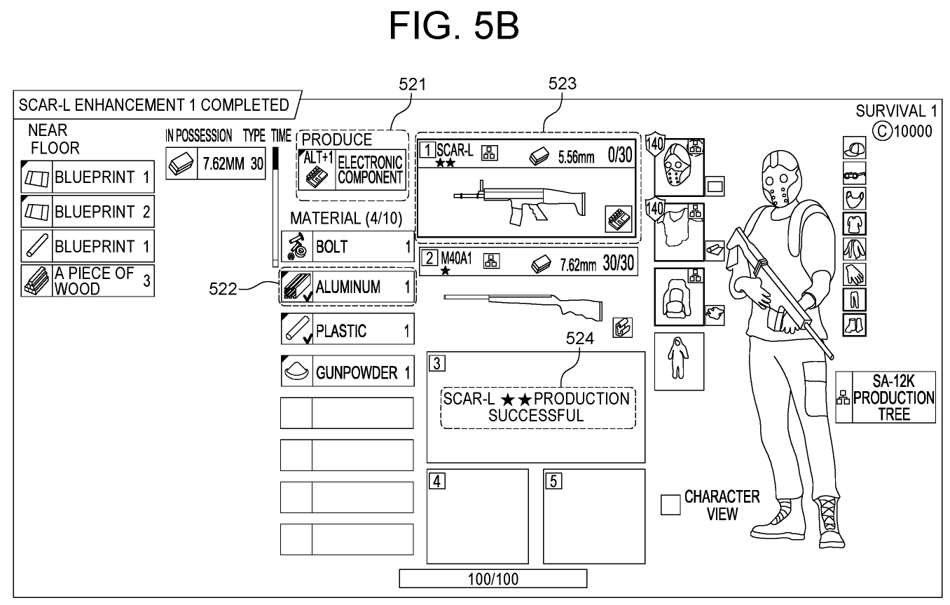

Meanwhile, the server 100 in accordance with one example embodiment of the present invention may support the specific user terminal to display information that at least part of the main upgrade process and the sub upgrade process is being performed or has been completed, and this is explained by referring to FIG. 5A and FIG. 5B.

FIG. 5A and FIG. 5B are drawings representing schematic illustrations of information related to upgrading in accordance with one example embodiment of the present invention.

Firstly, the process of the server 100 supporting the specific terminal to display information that at least part of the main upgrade process and the sub upgrade process is being performed is explained by referring to FIG. 5A.

For example, assuming that one aluminum is necessary to upgrade the 1-star SCAR-L to the 2-star SCAR-L, in response to acquiring the main upgrade request for the 1-star SCAR-L, as shown in FIG. 5A, the server 100 may support the specific user terminal to (i) display a degree of upgrade progress through areas 511, 512, 513 where the items related to upgrading of the 1-star SCAR-L (for example, the 1-star SCAR-L, the 2-star SCAR-L, the aluminum) are displayed, (ii) display the name of the completed item, guide message indicating that the upgrade is being performed and information 514 expressing the time left until the completion of the upgrade and the degree of progress in a form of a bar through at least part of the 2-nd display area, thereby informing the specific user that the upgrade for the 1-star SCAR-L is being performed.

However, the explanation above is merely one example for providing the information that the server 100 is performing the upgrade process to the specific user, and the present invention is not limited thereto.

As one example, the server 100 may allow the specific player to take a specific action (for example, hammering) in a 3-rd display area (for example, display area where the player can check a surrounding situation of a point where the player is located), other than the 2-nd display area 400 where the inventory information is displayed, thereby informing the specific user that the upgrade process is being performed.

As another example, the server 100 may support the specific user terminal to output sound (for example, sound of hammering) that the upgrade process is being performed, thereby informing the specific user that the upgrade process is being performed.

Next, the process of the server 100 supporting the specific terminal to display the information that at least part of the main upgrade process and the sub upgrade process has completed is explained.

For example, it is assumed that one 1-star SCAR-L and one aluminum are consumed to generate the 2-star SCAR-L.

As one example, as shown in FIG. 5, on condition that the 2-star SCAR-L is to be displayed in the “produce” area 511 where the item satisfying the upgrade condition is displayed, in response to acquiring the main upgrade request from the specific user terminal, the server 100 may generate the 2-star SCAR-L by using one 1-star SCAR-L and one aluminum and provide the 2-star SCAR-L to the specific player. Herein, as shown in FIG. 5B, it can be confirmed that (i) the 2-star SCAR-L is no longer displayed in the “produce” area 521, (ii) the aluminum displayed in the “material” area is displayed such that only one aluminum is in possession, (iii) the 2-star SCAR-L is displayed in the area where the main item in possession is displayed, and (iv) the name of the item which completed the upgrade and the guide message indicating that the upgrade has been completed are displayed through one section 524 of the 2-nd display area.

However, this is merely one example and the present invention is not limited thereto.

As one example, the server may allow the specific player to take a specific action (for example, an action of the specific player equipping the upgraded gun splendidly) in the 3-rd display area (for example, display area where the player can check the surrounding situation of the point where the player is located), other than the 2-nd display area 400 where the inventory information is displayed, thereby providing the information that the upgrade process has been completed to the specific user terminal.

As still another example, the server 100 may support the specific user terminal to output the sound (for example, guide speech such as “Upgrade has been completed”), thereby providing the information that the upgrade process has been completed to the specific user terminal.

Meanwhile, the server 100 in accordance with one example embodiment of the present invention may determine what item is currently not possessed by a player (that is, non-possessed item), among the necessary items for upgrading the item of the player participating in the battle royale game, and increase a probability of the non-possessed item being included in a supply box, thereby allowing the upgrade to be made efficiently.

As one example, assuming that a state of the plurality of players waiting in a waiting space in the battle royale game is the 1-st state, and a state of the plurality of players playing in the battle royale game is the 2-nd state, in response to determining that the (k_1)-st condition is not satisfied, the server 100 may perform a 1-st process of (1) increasing a probability of a 1-st non-possessed item being contained in a 1-st supply box to be provided in the 2-nd state by referring to at least part of (i) 1-st specific non-possessed item necessary for the specific player to satisfy the (k_1)-st condition, (ii) 1-st statistic information on the 1-st specific non-possessed item and 1-st another non-possessed item necessary for at least one another player to satisfy the (k_1)-st condition, (iii) at least one player level corresponding to at least part of the specific player and the another player and (iv) class information corresponding to the specific player and class information corresponding to the another player, and (2) determining a 1-st forwarding position of the 1-st supply box by referring to a position of the specific player and a position of the another player.

As another example, in response to determining that the (k_2)-nd condition is not satisfied, the server 100 may perform a 2-nd process of (1) increasing a probability of a 2-nd non-possessed item being contained in a 2-nd supply box to be provided in the 2-nd state by referring to at least part of (i) 2-nd specific non-possessed item necessary for the specific player to satisfy the (k_2)-nd condition, (ii) 2-nd statistic information on the 2-nd specific non-possessed item and 2-nd another non-possessed item necessary for the another player to satisfy the (k_2)-nd condition, (iii) the player level corresponding to at least part of the specific player and the another player and (iv) class information corresponding to the specific player and class information corresponding to the another player, and (2) determining a 2-nd forwarding position of the 2-nd supply box by referring to the position of the specific player and a position of the another player.

Meanwhile, the server 100 in accordance with one example embodiment of the present invention may support the players to disassemble the items of upper level to acquire their corresponding items of lower level.

Accordingly, opportunities of more various combinations of the items are provided to the users, and the players may establish various strategies in the extreme situation of competition for survival.

For example, at the later stage of the game, the necessity for the specific item may considerably increase, but because of the characteristic of the battle royale game, moving his or her base at the later stage of the game is very risky, and thus in most cases it is difficult for the players to collect specific material items necessary for producing the specific item through searching in the later stage of the game.

In such a case, the server 100 in accordance with one example embodiment of the present invention may support the players to disassemble the possessed items of upper level to acquire the items of lower level, and produce the specific item by using the necessary items at issue, thereby supporting the players to establish flexible strategies/tactics in various situations.

The present disclosure has an effect of supporting the players participating in a battle royale game to be capable of upgrading possessed items.

The present disclosure has an effect of supporting the players participating in a battle royale game to easily upgrade possessed items by providing upgrade tree information to the players.

The present disclosure has an effect of supporting the players participating in a battle royale game to easily upgrade possessed items by providing an inventory status window for checking the possessed items to the players.

The present disclosure has an effect of preventing users controlling the players participating in a battle royale game from losing interest in the game easily.

Besides, the embodiments of the present disclosure as explained above can be implemented in a form of executable program command through a variety of computer means recordable to computer readable media. The computer readable media may store solely or in combination, program commands, data files, and data structures. The program commands recorded in the media may be components specially designed for the present disclosure or may be usable for a skilled human in a field of computer software. The computer readable media include, but are not limited to, magnetic media such as hard drives, floppy diskettes, magnetic tapes, memory cards, solid-state drives, USB flash drives, optical media such as CD-ROM and DVD, magneto-optical media such as floptical diskettes and hardware devices such as a read-only memory (ROM), a random access memory (RAM), and a flash memory specially designed to store and carry out program commands. Program commands may include not only a machine language code made by a compiler but also a high level code that can be used by an interpreter etc., which is executed by a computer. The aforementioned hardware device may work as more than a software module to perform the action of the present disclosure and they may do the same in the opposite case. As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for providing a battle royale game which upgrades items, comprising steps of:
(a) on condition that (i) information on each of a 1-st main item to an n-th main item, (ii) information on at least one 1-st sub item corresponding to the 1-st main item to at least one n-th sub item corresponding to the n-th main item, wherein each of the 1-st sub item to the n-th sub item be consumed respectively for upgrading each of the 1-st main item to the n-th main item includes at least part of each of a (1_1) -st sub item to an (n_1)-st sub item directly consumed respectively for upgrading each of the 1-st main item to the n-th main item and each of a (1_2)-nd sub item to an (n_2)-nd sub item indirectly consumed respectively for upgrading the 1-st main item to the n-th main item, and (iii) 1-st hierarchy information to n-th hierarchy information, wherein each of the 1-st hierarchy information to the n-th hierarchy information includes each of information on hierarchy among levels of the 1-st main item to information on hierarchy among levels of the n-th main item, each of information on hierarchy among levels of the 1-st sub item to information on hierarchy among levels of the n-th sub item, and each of information on hierarchy between each of the levels of the 1-st main item and each of the levels of the 1-st sub item to information on hierarchy between each of the levels of the n-th main item and each of the levels of the n-th sub item, have been stored and managed in a database, a server acquiring at least part of a k-th main upgrade request for upgrading a k-th main item and a k-th sub upgrade request for upgrading a k-th sub item from a specific user terminal corresponding to a specific player among a plurality of players participating in the battle royale game, wherein the k is any one integer among 1 to n; and
(b) the server performing at least part of (i) a main upgrade process which upgrades the k-th main item and provides an upgraded status of the k-th main item to the specific player, in response to determining that a (k_1)-st condition for upgrading the k-th main item is satisfied by referring to information on one or more specific possessed items of the specific player, information on the k-th main item, information on the k-th sub item and k-th hierarchy information, wherein the k-th hierarchy information is information on hierarchy among levels of the k-th main item, information on hierarchy among levels of the k-th sub item, and information on hierarchy between each of the levels of the k-th main item and each of the levels of the k-th sub item, and (ii) a sub upgrade process which upgrades the k-th sub item and provides an upgraded status of the k-th sub item to the specific player, in response to determining that a (k_2)-nd condition for upgrading the k-th sub item is satisfied by referring to the information on the specific possessed items of the specific player, the information on the k-th sub item and the k-th hierarchy information.

2. The method of claim 1, wherein the step of (a) includes steps of:
(a1) on condition that information on each of the 1-st main item to the n-th main item, information on the at least one 1-st sub item to the at least one n-th sub item and the 1-st hierarchy information to the n-th hierarchy information have been stored and managed in the database, the server acquiring a request for k-th upgrade tree information corresponding to the k-th main item from the specific user terminal, wherein the k-th upgrade tree information is generated by referring to at least part of information on the k-th main item, information on the k-th sub item and the k-th hierarchy information; and
(a2) the server providing the k-th upgrade tree information to the specific user terminal and thus supporting the specific user terminal to generate at least part of the k-th main upgrade request for upgrading the k-th main item and the k-th sub upgrade request for upgrading the k-th sub item by referring to the k-th upgrade tree information, thereby acquiring at least part of the k-th main upgrade request and the k-th sub upgrade request from the specific user terminal.

3. The method of claim 2, wherein, at the step of (a2), the server provides the k-th upgrade tree information to the specific user terminal and thus supports the specific user terminal to display the k-th upgrade tree information through a 1-st display area, thereby supporting a specific user of the specific user terminal to generate at least part of the k-th main upgrade request and the k-th sub upgrade request, and
wherein the server further supports the specific user terminal to display a 1-st visual effect through at least one section in a (1_1)-st display area of the 1-st display area, wherein the (1_1)-st display area is an area where at least part of a k-th main possessed item and a k-th sub possessed item is displayed, and wherein the k-th main possessed item and the k-th sub possessed item are items corresponding to the specific possessed items of the specific player among the k-th main item and the k-th sub item.

4. The method of claim 2, wherein the step of (a1) has steps of:
(a1_1) on condition that information on each of the 1-st main item to the n-th main item, information on the at least one 1-st sub item to the at least one n-th sub item and the 1-st hierarchy information to the n-th hierarchy information have been stored and managed in the database, the server acquiring a request for specific inventory information including information on the specific possessed items of the specific player from the specific user terminal;
(a1_2) the server (i) transmitting the specific inventory information generated by referring to the information on the specific possessed items to the specific user terminal, and (ii) supporting the specific user terminal to display the specific inventory information through a 2-nd display area and further supporting the specific user terminal to display a first user interface through at least one section in a (2_1)-st display area of the 2-nd display area, wherein the (2_1)-st display area is an area where at least part of a k-th main possessed item and a k-th sub possessed item is displayed, and wherein the k-th main possessed item and the k-th sub possessed item are items corresponding to the specific possessed items of the specific player among the k-th main item and the k-th sub item, and wherein the first user interface is a user interface for acquiring a request for the k-th upgrade tree information from the specific user terminal; and
(a1_3) the server acquiring a selection signal for the first user interface as a request for the k-th upgrade tree information from the specific user terminal.

5. The method of claim 1, wherein the step of (a) includes steps of:
(a3) on condition that information on each of the 1-st main item to the n-th main item, information on the at least one 1-st sub item to the at least one n-th sub item and the 1-st hierarchy information to the n-th hierarchy information have been stored and managed in the database, the server acquiring specific inventory information including information on the specific possessed items of the specific player from the specific user terminal;
(a4) the server transmitting the specific inventory information generated by referring to information on the specific possessed items of the specific player to the specific user terminal and thus supporting the specific user terminal to display the specific inventory information through a 2-nd display area, and further supporting the specific user terminal to display a 2-nd visual effect through at least one section in a (2_2)-nd display area of the 2-nd display area, wherein the (2_2)-nd display area is an area where a subset of the specific possessed items corresponding to at least part of the (k_1)-st condition and the (k_2)-nd condition among the specific possessed items of the specific player is displayed; and
(a5) the server supporting a specific user of the specific user terminal to generate at least part of the k-th main upgrade request and the k-th sub upgrade request by referring to information on the subset of the specific possessed items, thereby acquiring at least part of the k-th main upgrade request and the k-th sub upgrade request from the specific user terminal.

6. The method of claim 1, wherein the step of (a) includes steps of:
(a6) on condition that information on each of the 1-st main item to the n-th main item, information on the at least one 1-st sub item to the at least one n-th sub item and the 1-st hierarchy information to the n-th hierarchy information have been stored and managed in the database, the server acquiring a request for specific inventory information including information on the specific possessed items of the specific player from the specific user terminal;
(a7) the server transmitting the specific inventory information generated by referring to the specific possessed items to the specific user terminal and thus supporting the specific user terminal to display the specific inventory information through a 2-nd display area, wherein the server performs at least one of (i) a process of supporting the specific user terminal to display at least part of information on at least one 1-st possessed item satisfying the (k_1)-st condition and at least one 2-nd possessed item satisfying the (k_2)-nd condition among the specific possessed items through a (2_3)-rd display area of the 2-nd display area and (ii) a process of determining the 2-nd possessed item satisfying the (k_2)-nd condition among the specific possessed items of the specific player, and supporting the specific user terminal to display information on the 2-nd possessed item through the (2_3)-rd display area of the 2-nd display area; and
(a8) the server supporting a specific user of the specific user terminal to generate at least part of the k-th main upgrade request and the k-th sub upgrade request by referring to at least part of information on the 1-st possessed item and information on the 2-nd possessed item, thereby acquiring at least part of the k-th main upgrade request and the k-th sub upgrade request from the specific user terminal.

7. The method of claim 1, wherein, at the step of (b), on condition that a state of the plurality of players waiting in a waiting space in the battle royale game is a 1-st state, and a state of the plurality of players playing in the battle royale game is a 2-nd state, the server performs at least part of:
a 1-st process, in response to determining that the (k_1)-st condition is not satisfied, of (1) increasing a probability of a 1-st non-possessed item being contained in a 1-st supply box to be provided in the 2-nd state by referring to at least part of (i) 1-st specific non-possessed item information necessary for the specific player to satisfy the (k_1)-st condition, (ii) 1-st statistic information on the 1-st specific non-possessed item information and 1-st another non-possessed item information necessary for at least one another player to satisfy the (k_1)-st condition, (iii) at least one player level corresponding to at least part of the specific player and another player and (iv) class information corresponding to the specific player and the another player, and (2) determining a 1-st forwarding position of the 1-st supply box by referring to a position of the specific player and a position of the another player, and
a 2-nd process, in response to determining that the (k_2)-nd condition is not satisfied, of (1) increasing a probability of a 2-nd non-possessed item being contained in a 2-nd supply box to be provided in the 2-nd state by referring to at least part of (i) 2-nd specific non-possessed item information necessary for the specific player to satisfy the (k_2)-nd condition, (ii) 2-nd statistic information on the 2-nd specific non-possessed item information and 2-nd another non-possessed item information necessary for the another player to satisfy the (k_2)-nd condition, (iii) the player level corresponding to at least part of the specific player and the another player and (iv) class information corresponding to the specific player and the another player, and (2) determining a 2-nd forwarding position of the 2-nd supply box by referring to the position of the specific player and a position of the another player.

8. The method of claim 1, wherein the k-th main item includes a (k_1)-th level main item to a (k_mk)-th level main item, and
wherein the k-th sub item includes at least part of a (k_1_1)-st sub item directly consumed for upgrading the (k_1)-st level main item and a (k_2_1)-st sub item indirectly consumed for upgrading the (k_1)-st level main item, at least part of a (k_1_2)-nd sub item directly consumed for upgrading the (k_2)-nd level main item and a (k_2_2)-nd sub item indirectly consumed for upgrading the (k_2)-nd level main item, ..., and at least part of a (k_1_(mk-1))-th sub item directly consumed for upgrading the (k_(mk-1))-th level main item and a (k 2 (mk-1))-th sub item indirectly consumed for upgrading the (k_(mk-1))-th level main item.

9. The method of claim 8, wherein, at the step of (a), the server acquires a (k_jk)-th main upgrade request for upgrading a (k_jk)-th level main item among the (k_1)-st level main item to the (k_mk)-th level main item from the specific user terminal as the k-th main upgrade request, and
wherein, at the step of (b), in the main upgrade process, in response to determining that the (k_1)-st condition is satisfied by referring to (i) the specific possessed items, (ii) information on the (k_jk)-th level main item and (k_(j+1)k)-th level main item, (iii) information on (k_1_jk)-th sub item and (iv) (k_jk)-th hierarchy information, wherein the (k_jk)-th hierarchy information is information on hierarchy among levels of the (k_jk)-th level main item and (k_(j+1)k)-th level main item, information on hierarchy between each of the levels of the (k_jk) -th level main item and each of the levels of the (k_1_jk)-th sub item, and information on hierarchy between each of the levels of the (k_(j+1)k)-th level main item and each of the levels of the (k_1_jk)-th sub item, the server provides the (k_(j+1)k)-th level main item, which is generated by upgrading the (k_jk)-th level main item by using the (k_1_jk)-th sub item, to the specific player.

10. The method of claim 8, wherein the step of (a) includes steps of:
(a9) on condition that information on each of the 1-st main item to the n-th main item, information on the at least one 1-st sub item to the at least one n-th sub item and the 1-st hierarchy information to the n-th hierarchy information have been stored and managed in the database, the server acquiring a request for (k_jk)-th upgrade tree information corresponding to (k_jk)-th level main item among the (k_1)-th level main item to the (k_mk)-th level main item from the specific user terminal, wherein the (k_jk)-th upgrade tree information is generated by referring to at least part of (i) information on the (k_jk)-th level main item and (k_(j+1)k)-th level main item, (ii) information on (k_1_jk)-th sub item and (iii) information on hierarchy among levels of the (k_jk)-th level main item and (k_(j+1)k)-th level main item, information on hierarchy between each of the levels of the (kjk)-th level main item and each of the levels of the (k_1_jk)-th sub item, and information on hierarchy between each of the levels of the (k_(j+1)k)-th level main item and each of the levels of the (k_1_jk)-th sub item; and
(a10) the server providing the (kjk)-th upgrade tree information to the specific user terminal and thus supporting the specific user terminal to generate (k_jk)-th main upgrade request for upgrading the (k_jk)-th level main item by referring to the (k_jk)-th upgrade tree information, thereby acquiring the (k_jk)-th main upgrade request from the specific user terminal as the k-th main upgrade request.

11. The method of claim 10, wherein at the step of (a10), the server provides the (k_jk)-th upgrade tree information to the specific user terminal and thus supports the specific user terminal to display the (k_jk)-th upgrade tree information through a 1-st display area, thereby supporting the specific user terminal to generate the (k_jk)-th main upgrade request for upgrading the (k_jk)-th level main item,
wherein the server further supports the specific user terminal to display a 3-rd visual effect through at least one section in a (1_2)-nd display area of the 1-st display area, wherein the (1_2)-nd display area is an area where at least part of a specific k-th lower level item is displayed, and wherein the specific k-th lower level item is at least one of (i) at least part of a (k_1_1)-st sub item directly consumed for upgrading the (k_1)-st level main item and a (k_2_1)-st sub item indirectly consumed for upgrading the (k_1)-st level main item, at least part of a (k_1_2)-nd sub item directly consumed for upgrading the (k_2)-nd level main item and a (k_2_2)-nd sub item indirectly consumed for upgrading the (k_2)-nd level main item, ..., and at least part of a (k_1_(jk-1))-st sub item directly consumed for upgrading the (k_(jk-1))-st level main item and a (k_2_(jk-1))-st sub item indirectly consumed for upgrading the (k_(jk-1) )-st level main item, and (ii) an item of the (k_1)-st level main item to the (k_(jk-1) )-st level main item.

12. A server for providing a battle royale game which upgrades items, comprising:
at least one memory that stores instructions; and
at least one processor configured to execute the instructions to perform or support another device to perform processes of: (I) on condition that (i) information on each of a 1-st main item to an n-th main item, (ii) information on at least one 1-st sub item corresponding to the 1-st main item to at least one n-th sub item corresponding to the n-th main item, wherein each of the 1-st sub item to the n-th sub item be consumed respectively for upgrading each of the 1-st main item to the n-th main item includes at least part of each of a (1_1) -st sub item to an (n_1)-st sub item directly consumed respectively for upgrading each of the 1-st main item to the n-th main item and each of a (1_2)-nd sub item to an (n_2)-nd sub item indirectly consumed respectively for upgrading the 1-st main item to the n-th main item, and (iii) 1-st hierarchy information to n-th hierarchy information, wherein each of the 1-st hierarchy information to the n-th hierarchy information includes each of information on hierarchy among levels of the 1-st main item to information on hierarchy among levels of the n-th main item, each of information on hierarchy among levels of the 1-st sub item to information on hierarchy among levels of the n-th sub item, and each of information on hierarchy between each of the levels of the 1-st main item and each of the levels of the 1-st sub item to information on hierarchy between each of the levels of the n-th main item and each of the levels of the n-th sub item, have been stored and managed in a database, acquiring at least part of a k-th main upgrade request for upgrading a k-th main item and a k-th sub upgrade request for upgrading a k-th sub item from a specific user terminal corresponding to a specific player among a plurality of players participating in the battle royale game, wherein the k is any one integer among 1 to n; and (II) performing at least part of (i) a main upgrade process which upgrades the k-th main item and provides an upgraded status of the k-th main item to the specific player, in response to determining that a (k_1) -st condition for upgrading the k-th main item is satisfied by referring to information on one or more specific possessed items of the specific player, information on the k-th main item, information on the k-th sub item and k-th hierarchy information, wherein the k-th hierarchy information is information on hierarchy among levels of the k-th main item, information on hierarchy among levels of the k-th sub item, and information on hierarchy between each of the levels of the k-th main item and each of the levels of the k-th sub item, and (ii) a sub upgrade process which upgrades the k-th sub item and provides an upgraded status of the k-th sub item to the specific player, in response to determining that a (k_2) -nd condition for upgrading the k-th sub item is satisfied by referring to the information on the specific possessed items of the specific player, the information on the k-th sub item and the k-th hierarchy information.

13. The server of claim 12, wherein the process of (I) includes processes of:
(I_1) on condition that information on each of the 1-st main item to the n-th main item, information on the at least one 1-st sub item to the at least one n-th sub item and the 1-st hierarchy information to the n-th hierarchy information have been stored and managed in the database, acquiring a request for k-th upgrade tree information corresponding to the k-th main item from the specific user terminal, wherein the k-th upgrade tree information is generated by referring to at least part of information on the k-th main item, information on the k-th sub item and the k-th hierarchy information; and
(I_2) providing the k-th upgrade tree information to the specific user terminal and thus supporting the specific user terminal to generate at least part of the k-th main upgrade request for upgrading the k-th main item and the k-th sub upgrade request for upgrading the k-th sub item by referring to the k-th upgrade tree information, thereby acquiring at least part of the k-th main upgrade request and the k-th sub upgrade request from the specific user terminal.

14. The server of claim 13, wherein, at the process of (I_2), the processor provides the k-th upgrade tree information to the specific user terminal and thus supports the specific user terminal to display the k-th upgrade tree information through a 1-st display area, thereby supporting a specific user of the specific user terminal to generate at least part of the k-th main upgrade request and the k-th sub upgrade request, and
wherein the processor further supports the specific user terminal to display a 1-st visual effect through at least one section in a (1_1)-st display area of the 1-st display area, wherein the (1_1)-st display area is an area where at least part of a k-th main possessed item and a k-th sub possessed item is displayed, and wherein the k-th main possessed item and the k-th sub possessed item are items corresponding to the specific possessed items of the specific player among the k-th main item and the k-th sub item.

15. The server of claim 13, wherein the process of (I_1) has processes of:
(I_1_1) on condition that information on each of the 1-st main item to the n-th main item, information on the at least one 1-st sub item to the at least one n-th sub item and the 1-st hierarchy information to the n-th hierarchy information have been stored and managed in the database, acquiring a request for specific inventory information including information on the specific possessed items of the specific player from the specific user terminal;
(I_1_ 2) (i) transmitting the specific inventory information generated by referring to the information on the specific possessed items to the specific user terminal, and (ii) supporting the specific user terminal to display the specific inventory information through a 2-nd display area and further supporting the specific user terminal to display a first user interface through at least one section in a (2_1)-st display area of the 2-nd display area, wherein the (2_1)-st display area is an area where at least part of a k-th main possessed item and a k-th sub possessed item is displayed, and wherein the k-th main possessed item and the k-th sub possessed item are items corresponding to the specific possessed items of the specific player among the k-th main item and the k-th sub item, and wherein the first user interface is a user interface for acquiring a request for the k-th upgrade tree information from the specific user terminal; and
(I_1_3) acquiring a selection signal for the first user interface as a request for the k-th upgrade tree information from the specific user terminal.

16. The server of claim 12, wherein the process of (I) includes processes of:
(I_3) on condition that information on each of the 1-st main item to the n-th main item, information on the at least one 1-st sub item to the at least one n-th sub item and the 1-st hierarchy information to the n-th hierarchy information have been stored and managed in the database, acquiring specific inventory information including information on the specific possessed items of the specific player from the specific user terminal;
(I_4) transmitting the specific inventory information generated by referring to information on the specific possessed items of the specific player to the specific user terminal and thus supporting the specific user terminal to display the specific inventory information through a 2-nd display area, and further supporting the specific user terminal to display a 2-nd visual effect through at least one section in a (2_2)-nd display area of the 2-nd display area, wherein the (2_2)-nd display area is an area where a subset of the specific possessed items corresponding to at least part of the (k_1)-st condition and the (k_2)-nd condition among the specific possessed items of the specific player is displayed; and
(I_5) supporting a specific user of the specific user terminal to generate at least part of the k-th main upgrade request and the k-th sub upgrade request by referring to information on the subset of the specific possessed items, thereby acquiring at least part of the k-th main upgrade request and the k-th sub upgrade request from the specific user terminal.

17. The server of claim 12, wherein the process of (I) includes processes of:
(I_6) on condition that information on each of the 1-st main item to the n-th main item, information on the at least one 1-st sub item to the at least one n-th sub item and the 1-st hierarchy information to the n-th hierarchy information have been stored and managed in the database, acquiring a request for specific inventory information including information on the specific possessed items of the specific player from the specific user terminal;
(I_7) transmitting the specific inventory information generated by referring to the specific possessed items to the specific user terminal and thus supporting the specific user terminal to display the specific inventory information through a 2-nd display area, wherein the server performs at least one of (i) a process of supporting the specific user terminal to display at least part of information on at least one 1-st possessed item satisfying the (k_1)-st condition and at least one 2-nd possessed item satisfying the (k_2)-nd condition among the specific possessed items through a (2_3)-rd display area of the 2-nd display area and (ii) a process of determining the 2-nd possessed item satisfying the (k_2)-nd condition among the specific possessed items of the specific player, and supporting the specific user terminal to display information on the 2-nd possessed item through the (2_3)-rd display area of the 2-nd display area; and
(I_8) supporting a specific user of the specific user terminal to generate at least part of the k-th main upgrade request and the k-th sub upgrade request by referring to at least part of information on the 1-st possessed item and information on the 2-nd possessed item, thereby acquiring at least part of the k-th main upgrade request and the k-th sub upgrade request from the specific user terminal.

18. The server of claim 12, wherein, at the process of (II), on condition that a state of the plurality of players waiting in a waiting space in the battle royale game is a 1-st state, and a state of the plurality of players playing in the battle royale game is a 2-nd state, the processor performs or supports another device to perform at least part of:
a 1-st process, in response to determining that the (k_1)-st condition is not satisfied, of (1) increasing a probability of a 1-st non-possessed item being contained in a 1-st supply box to be provided in the 2-nd state by referring to at least part of (i) 1-st specific non-possessed item information necessary for the specific player to satisfy the (k_1)-st condition, (ii) 1-st statistic information on the 1-st specific non-possessed item information and 1-st another non-possessed item information necessary for at least one another player to satisfy the (k_1)-st condition, (iii) at least one player level corresponding to at least part of the specific player and another player and (iv) class information corresponding to the specific player and the another player, and (2) determining a 1-st forwarding position of the 1-st supply box by referring to a position of the specific player and a position of the another player, and
a 2-nd process, in response to determining that the (k_2)-nd condition is not satisfied, of (1) increasing a probability of a 2-nd non-possessed item being contained in a 2-nd supply box to be provided in the 2-nd state by referring to at least part of (i) 2-nd specific non-possessed item information necessary for the specific player to satisfy the (k_2)-nd condition, (ii) 2-nd statistic information on the 2-nd specific non-possessed item information and 2-nd another non-possessed item information necessary for the another player to satisfy the (k_2)-nd condition, (iii) the player level corresponding to at least part of the specific player and the another player and (iv) class information corresponding to the specific player and the another player, and (2) determining a 2-nd forwarding position of the 2-nd supply box by referring to the position of the specific player and a position of the another player.

19. The server of claim 12, wherein the k-th main item includes a (k_1)-th level main item to a (k_mk)-th level main item, and
wherein the k-th sub item includes at least part of a (k_1_1)-st sub item directly consumed for upgrading the (k_1)-st level main item and a (k_2_1)-st sub item indirectly consumed for upgrading the (k_1)-st level main item, at least part of a (k_1_2)-nd sub item directly consumed for upgrading the (k_2)-nd level main item and a (k_2_2)-nd sub item indirectly consumed for upgrading the (k_2)-nd level main item, ..., and at least part of a (k_1_(mk-1))-th sub item directly consumed for upgrading the (k_(mk-1))-th level main item and a (k_2_ (mk-1))-th sub item indirectly consumed for upgrading the (k_(mk-1))-th level main item.

20. The server of claim 19, wherein, at the process of (I), the processor acquires a (k_jk)-th main upgrade request for upgrading a (k_jk)-th level main item among the (k_1)-st level main item to the (k_mk)-th level main item from the specific user terminal as the k-th main upgrade request, and
wherein, at the process of (II), in the main upgrade process, in response to determining that the (k_1)-st condition is satisfied by referring to (i) the specific possessed items, (ii) information on the (k_jk)-th level main item and (k_(j+1)k)-th level main item, (iii) information on (k_1_jk)-th sub item and (iv) (k_jk)-th hierarchy information, wherein the (k_jk)-th hierarchy information is information on hierarchy among levels of the (k_jk)-th level main item and (k_(j+1)k)-th level main item, information on hierarchy between each of the levels of the (k_j k) -th level main item and each of the levels of the (k_1_jk)-th sub item, and information on hierarchy between each of the levels of the (k_(j+1)k)-th level main item and each of the levels of the (k_1_jk)-th sub item, the server provides the (k_(j+1)k)-th level main item, which is generated by upgrading the (k_jk)-th level main item by using the (k_1_jk)-th sub item, to the specific player.

21. The server of claim 19, wherein the process of (I) includes processes of:
(I_9) on condition that information on each of the 1-st main item to the n-th main item, information on the at least one 1-st sub item to the at least one n-th sub item and the 1-st hierarchy information to the n-th hierarchy information have been stored and managed in the database, acquiring a request for (k_jk)-th upgrade tree information corresponding to (k_jk)-th level main item among the (k_1)-th level main item to the (k_mk)-th level main item from the specific user terminal, wherein the (k_jk)-th upgrade tree information is generated by referring to at least part of (i) information on the (k_jk)-th level main item and (k_(j+1)k)-th level main item, (ii) information on (k_1_jk)-th sub item and (iii) information on hierarchy among levels of the (k_jk)-th level main item and (k_(j+1)k)-th level main item, information on hierarchy between each of the levels of the (k_jk)-th level main item and each of the levels of the (k_1_jk)-th sub item, and information on hierarchy between each of the levels of the (k_(j+1)k)-th level main item and each of the levels of the (k_1_jk)-th sub item; and
(I_10) providing the (k_jk)-th upgrade tree information to the specific user terminal and thus supporting the specific user terminal to generate (k_jk)-th main upgrade request for upgrading the (k_jk)-th level main item by referring to the (k_jk)-th upgrade tree information, thereby acquiring the (k_jk)-th main upgrade request from the specific user terminal as the k-th main upgrade request.

22. The server of claim 21, wherein at the process of (I_10), the processor provides the (k_jk)-th upgrade tree information to the specific user terminal and thus supports the specific user terminal to display the (k_jk)-th upgrade tree information through a 1-st display area, thereby supporting the specific user terminal to generate the (k_jk)-th main upgrade request for upgrading the (k_jk)-th level main item,
wherein the processor further supports the specific user terminal to display a 3-rd visual effect through at least one section in a (1_2)-nd display area of the 1-st display area, wherein the (1_2)-nd display area is an area where at least part of a specific k-th lower level item is displayed, and wherein the specific k-th lower level item is at least one of (i) at least part of a (k_1_1)-st sub item directly consumed for upgrading the (k_1)-st level main item and a (k_2_1)-st sub item indirectly consumed for upgrading the (k_1)-st level main item, at least part of a (k_1_2)-nd sub item directly consumed for upgrading the (k_2)-nd level main item and a (k_2_2)-nd sub item indirectly consumed for upgrading the (k_2)-nd level main item, ..., and at least part of a (k_1_(jk-1))-st sub item directly consumed for upgrading the (k_(jk-1))-st level main item and a (k_2_(jk-1))-st sub item indirectly consumed for upgrading the (k_(jk-1))-st level main item, and (ii) an item of the (k_1)-st level main item to the (k_(jk-1))-st level main item.
